(19) United States
(12) Patent Application Publication
(10) Pub. No.: US 2026/0302634 A1
(43) Pub. Date: Oct. 1, 2026

(54) SYSTEM AND METHOD FOR FACILITATING RADIO FREQUENCY TRANSMISSION THROUGH A GLAZING ASSEMBLY INCLUDING A CONDUCTIVE COATING

(71) Applicant: AGC Automotive Americas Co., Alpharetta, GA (US)

(72) Inventors: Jiangping Wang, Novi, MI (US); Tatuo Yajima, Ann Arbor, MI (US); Kyle Wayne Harman, Ypsilanti, MI (US); Frederick Maurice Schaible, III, Ann Arbor, MI (US); Abdelhalim Mohamed, Canton, MI (US); Kadosa Hevesi, Namur (BE)

(21) Appl. No.: 19/093,681

(22) Filed: Mar. 28, 2025

(51) Int. Cl. H01Q 15/00; H01Q 1/12

(52) U.S. Cl. CPC H01Q 15/0013; H01Q 1/1271

(57) ABSTRACT

A system includes a glazing assembly including a glass substrate having a first surface and an opposing second surface, and a conductive coating at least partially disposed on at least one of the first surface and the second surface of the glass substrate. The conductive coating inhibits transmission of radio frequency signals therethrough. The glazing assembly also includes an enamel at least partially disposed relative to a portion of the conductive coating and heated to at least partially dissolve the portion of the conductive coating to establish a decoated region on the at least one of the first surface and the second surface to permit transmission of radio frequency signals therethrough. The system further includes an antenna assembly arranged relative to the glazing assembly such that the antenna assembly is configured to be energized to transmit and/or receive radio frequency signals through the decoated region.

### TECHNICAL FIELD

The present disclosure relates generally to systems and methods for facilitating radio frequency transmission through a glazing assembly including a conductive coating and, more specifically, to systems and methods including a glazing assembly including a glass substrate having a conductive coating with a decoated region and an antenna assembly configured to be energized to transmit and/or receive radio frequency signals through the decoated region.

### BACKGROUND

There is a significant attenuation of radio frequency (RF) transmittance through glazing assemblies including a glass substrate having a conductive coating disposed on a surface thereof. Thus, conventionally, antenna assemblies are not typically disposed relative to these glazing assemblies. Alternatively, prohibitively expensive and/or labor intensive measures such as masking during application of the conductive coating, laser ablation of the conductive coating, mechanical decoating of the conductive coating, dedicated chemical etching processes for removing the conductive coating, etc. are taken to selectively remove portions of these conductive coatings to permit transmission of radio frequency signals therethrough. In addition to being prohibitively expensive and/or labor intensive, these alternative measures are also known to produce suboptimal results. For example, the alternative measures may lead to edges of the conductive coating being visible to an observer and/or, when subjected to heat, the glazing assembly may heat unevenly between the coated and decoated regions, leading to optical distortion.

Additionally, when a conventional black ceramic enamel is applied relative to conductive coatings and subsequently fired, there are known issues with these conventional black ceramic enamels experiencing discoloration (e.g. yellowing and/or a loss of opacity) due to the chemical interaction of the conventional black ceramic enamel with the adjacent conductive coating. Particularly, the conductive components of the conductive coating (e.g. silver) are known to experience an oxidation-reduction reaction with the conventional black ceramic enamel which leads to such discoloration.

Furthermore, for laminated glazing assemblies, when a conventional black ceramic enamel is applied relative to conductive coatings and subsequently fired, there are known issues with these conventional black ceramic enamels not adequately bonding with the polymeric interlayer, leading to possible delamination of the laminated glazing assembly.

In view of the above, there is a need for an improved systems and methods for facilitating radio frequency transmission through a glazing assembly including a conductive coating.

### SUMMARY AND ADVANTAGES

The present disclosure is generally directed to a system for facilitating radio frequency transmission including a glazing assembly. The glazing assembly includes a glass substrate having a first surface and an opposing second surface, and a conductive coating at least partially disposed on at least one of the first surface and the second surface of the glass substrate. The conductive coating inhibits transmission of radio frequency signals therethrough. The glazing assembly also includes an enamel at least partially disposed relative to a portion of the conductive coating to at least partially dissolve the portion of the conductive coating to establish a decoated region on the at least one of the first surface and the second surface to permit transmission of radio frequency signals therethrough. The system further includes an antenna assembly arranged relative to the glazing assembly such that the antenna assembly is configured to be energized to transmit and/or receive radio frequency signals through the decoated region.

The present disclosure is also generally directed to a system for facilitating radio frequency transmission including a laminated glazing assembly. The laminated glazing assembly includes a first glass substrate having a first surface (P1) and an opposing second surface (P2), a second glass substrate having a third surface (P3) and an opposing fourth surface (P4), and a polymeric interlayer disposed between the P2 surface and the P3 surface. The laminated glazing assembly also includes a conductive coating at least partially disposed on at least one of the P1 surface, the P2 surface, the P3 surface, and the P4 surface. The conductive coating inhibits transmission of radio frequency signals therethrough. The laminated glazing assembly further includes an enamel at least partially disposed relative to a portion of the conductive coating to at least partially dissolve the portion of the conductive coating to define a decoated region on the at least one of the P1 surface, the P2 surface, the P3 surface, and the P4 surface to permit transmission of radio frequency signals therethrough. The system additionally includes an antenna assembly arranged relative to the laminated glazing assembly such that the antenna assembly is configured to be energized to transmit and/or receive radio frequency signals through the decoated region.

The present disclosure is further generally directed to a method including providing a glass substrate having a first surface and an opposing second surface, and disposing a conductive coating at least partially on at least one of the first surface and the second surface of the glass substrate. The conductive coating inhibits transmission of radio frequency signals therethrough. The method also includes disposing an enamel at least partially relative to a portion of the conductive coating, and heating the glass substrate, the conductive coating, and the enamel such that the enamel at least partially dissolves the portion of the conductive coating to establish a decoated region on the at least one of the first surface and the second surface. The method further includes disposing an antenna assembly relative to the glass substrate such that the antenna assembly is configured to be energized to transmit and/or receive radio frequency signals through the decoated region.

Advantageously, the systems and method according to the present disclosure permit antenna assemblies to transmit and/or receive radio frequency signals through the decoated region of the glazing assembly established via the enamel (i.e., without the need for prohibitively expensive and/or labor intensive measures to remove the conductive coating).

### BRIEF DESCRIPTION OF THE DRAWINGS

Advantages of the present disclosure will be readily appreciated as the same becomes better understood by reference to the following detailed description when considered in connection with the accompanying drawings.

FIG. 1 is a rear perspective view of a vehicle including one example of a system including a glazing assembly according to the present disclosure.

FIG. 2 is a flowchart illustrating a method according to the present disclosure.

FIG. 3 is a cross-sectional schematic representation of a step of providing a glass substrate having a first surface and an opposing second surface.

FIG. 4 is a flowchart illustrating a variation of the method according to the present disclosure.

FIGS. 5A-5C are cross-sectional schematic representations of one example of a step of disposing a conductive coating at least partially on at least one of the first surface and the second surface of the glass substrate.

FIGS. 6A-6C are cross-sectional schematic representations of one example of a step of disposing an enamel at least partially relative to a portion of the conductive coating.

FIG. 7 is a flowchart illustrating another variation of the method according to the present disclosure.

FIGS. 8A-8C are cross-sectional schematic representations of another example of a step of disposing an enamel at least partially on at least one of the first surface and the second surface of the glass substrate.

FIGS. 9A-9C are cross-sectional schematic representations of another example of a step of disposing a conductive coating at least partially on at least one of the first surface and the second surface of the glass substrate such that the enamel is disposed at least partially relative to a portion of the conductive coating.

FIGS. 10A-10C are cross-sectional schematic representations of a step of heating the glass substrate, the conductive coating, and the enamel such that the enamel at least partially dissolves the portion of the conductive coating to establish a decoated region on the at least one of the first surface and the second surface.

FIGS. 11A-11C are cross-sectional schematic representations of a step of disposing an antenna assembly relative to the glass substrate such that the antenna assembly is configured to be energized to transmit and/or receive radio frequency signals through the decoated region.

FIG. 12 is a front schematic representation of one example of the system including the glazing assembly where the enamel is formed as a band extending around a peripheral edge of the glazing assembly.

FIGS. 13A-13C are cross-sectional schematic representations of another example of the system including the glazing assembly including an antenna assembly including a radiating portion printed or otherwise formed on the glass substrate taken along line A-A of FIG. 1.

FIGS. 14A-14C are cross-sectional schematic representations of another example of the system including the glazing assembly including an antenna assembly including a carrier layer coupled to the glass substrate and supporting the radiating portion taken along line A-A of FIG. 1.

FIGS. 15A-15C are cross-sectional schematic representations of another example of the system including the glazing assembly including an antenna assembly realized as an antenna module including a housing coupled to the glass substrate and enclosing the radiating portion taken along line A-A of FIG. 1.

FIGS. 16A-16C are cross-sectional schematic representations of another example of the system including the glazing assembly including an antenna assembly realized as an antenna module including a housing supported elsewhere in the vehicle and enclosing the radiating portion taken along line A-A of FIG. 1.

FIG. 17 is a partial front schematic representation of another example of the system including the glazing assembly where the decoated region defines an island and the antenna assembly includes a radiating portion within the island to transmit and/or receive radio frequency signals through the slot.

FIG. 18 is a partial front schematic representation of another example of the system including the glazing assembly where the decoated region defines a slot and the antenna assembly includes a radiating portion within the island to transmit and/or receive radio frequency signals through the slot.

FIG. 19 is a partial front schematic representation of another example of the system including the glazing assembly where the decoated region defines a slot and the antenna assembly includes a feeding portion coupled to the slot to energize the slot to transmit and/or receive radio frequency signals.

FIG. 20 is a flowchart illustrating another variation of the method according to the present disclosure further including a step of disposing a second enamel, different from the first enamel, over at least a portion of the first enamel.

FIGS. 21A-21C are cross-sectional schematic representations of a variation of the method according to the present disclosure where the enamel is a first enamel and the method further includes a step of disposing a second enamel, different from the first enamel, over at least a portion of the first enamel.

FIGS. 22A-22C are cross-sectional schematic representations of a step of heating the glass substrate, the conductive coating, the first and the second enamel.

FIG. 23 is a front view of a vehicle including one example of the system including a laminated glazing assembly according to the present disclosure.

FIG. 24 is a flowchart illustrating a variation of the method according to the present disclosure where the glazing assembly is an laminated glazing assembly.

FIG. 25 is an exploded cross-sectional schematic representation of a laminated glazing assembly according to the present disclosure including a first glass substrate, a second glass substrate, and a polymeric interlayer.

FIG. 26 is a cross-sectional schematic representation of the laminated glazing of FIG. 25 with the first glass substrate and the second glass substrate coupled to the polymeric interlayer.

FIG. 27 is a cross-sectional schematic representation of a step of disposing an antenna assembly relative to the one of the glass substrates of the laminated glazing assembly such that the antenna assembly is configured to be energized to transmit and/or receive radio frequency signals through the decoated region(s) of the laminated glazing assembly.

FIG. 28 is a cross-sectional schematic representation of one example of the system including the laminated glazing assembly including an antenna assembly including a radiating portion printed or otherwise formed on one of the glass substrates of the laminated glazing assembly taken along line B-B of FIG. 23.

FIG. 29 is a cross-sectional schematic representation of another example of the system including the laminated glazing assembly including an antenna assembly including a carrier layer coupled to one of the glass substrates and supporting the radiating portion taken along line B-B of FIG. 23.

FIG. 30 is cross-sectional schematic representation of another example of the system including the laminated glazing assembly including an antenna assembly realized as an antenna module including a housing coupled to one of the glass substrates and enclosing the radiating portion taken along line B-B of FIG. 23.

FIG. 31 is cross-sectional schematic representation of another example of the system including the laminated glazing assembly including an antenna assembly realized as an antenna module including a housing supported elsewhere in the vehicle and enclosing the radiating portion taken along line B-B of FIG. 23.

FIGS. 32A and 32B are cross-sectional schematic representations of examples of the system including the laminated glazing assembly where the antenna assembly includes a passive radiating portion disposed between the first glass substrate and the second glass substrate taken along line B-B of FIG. 23.

FIGS. 33A and 33B are cross-sectional schematic representations of examples of the system including the laminated glazing assembly where the antenna assembly includes an active/steerable radiating portion disposed between the first glass substrate and the second glass substrate taken along line B-B of FIG. 23.

FIG. 34 is a top schematic representation of a vehicle including another example of the system including a laminated glazing assembly according to the present disclosure realized as a laminated roof glass panel.

FIG. 35 is a schematic cross-sectional representations of one example of the system including the laminated roof glass panel taken along line C-C of FIG. 34.

FIG. 36 is a flowchart illustrating a variation of the method according to the present disclosure where the glazing assembly is an insulated glazing assembly.

FIG. 37 is a front schematic representation of an insulated glazing assembly installed relative to a building.

FIG. 38 is a schematic cross-sectional representation of one example of the insulated glazing assembly taken along line D-D of FIG. 37.

### DETAILED DESCRIPTION

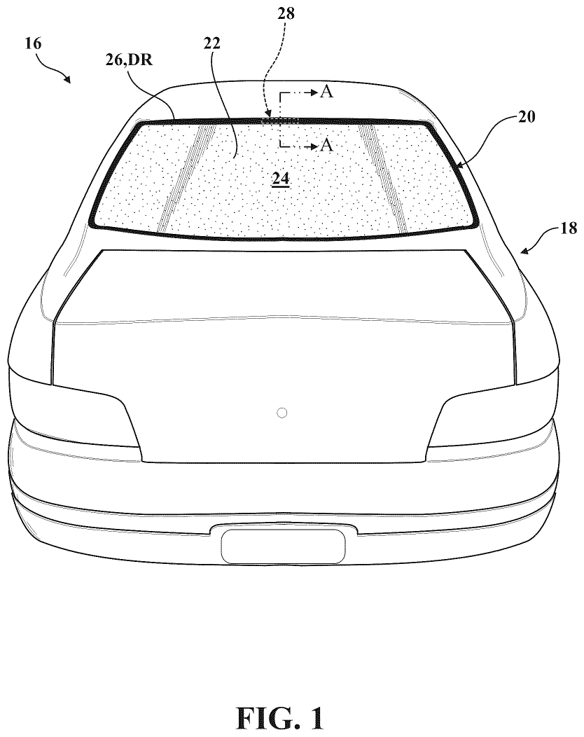

Referring to the drawings, wherein like reference numerals are used to identify like or identical components in the various views, FIG. 1 illustrates one example of a system 16 for facilitating radio frequency transmission through glazing assemblies 20 including a conductive coating 24 according to the present disclosure. The system 16 generally includes a glazing assembly 20. The implementation of the glazing assembly 20 is not necessarily limited for the purposes of this disclosure. For example, the glazing assembly 20 may be disposed in an opening defined by a vehicle 18 (e.g., a train, a plane, an automobile, etc.) or in an opening defined by a building 19. In the illustrated example, the glazing assembly 20 is a rear window of a vehicle 18, but it should also be appreciated that where employed in vehicles, the glazing assemblies 20 according to the present disclosure may also be windshields, side windows, quarter windows, roof glass panels, and the like. As described in further detail below, the glazing assembly 20 generally includes a glass substrate 22, a conductive coating 24 (which inhibits transmission of radio frequency signals therethrough) at least partially disposed on at least one surface of the glass substrate 22, an enamel 26 at least partially disposed relative to a portion 25 of the conductive coating 24 to at least partially dissolve the portion 25 of the conductive coating 24 to establish a decoated region DR to permit transmission of radio frequency signals therethrough. The system 16 also includes an antenna assembly 28 arranged relative to the glazing assembly 20 such that the antenna assembly 28 is configured to be energized to transmit and/or receive radio frequency signals (i.e., electromagnetic waves used for wireless communication) through the decoated region DR.

In some examples, the glazing assembly 20 includes a single glass substrate 22 (which is typically tempered or otherwise heat treated). In other examples, the glazing assembly 20 may include multiple glass substrates 22. For example, as described in further detail below, the glazing assembly 20 may be formed as a laminated glazing assembly 120 including multiple glass substrates 22 laminated together (typically via one or more polymeric interlayers). In another example, as also described in further detail below, the glazing assembly 20 may be formed as an insulated glazing assembly 220 including multiple glass substrates spaced apart (e.g. double-paned building windows, triple-paned building windows, etc.). In these examples, the glazing assembly 20 may include spacers to define the spacing between the glass substrates, seals to seal the space between the glass substrates, and fill gasses (e.g. argon) disposed in the space between the glass substrates 22 to reduce heat transfer.

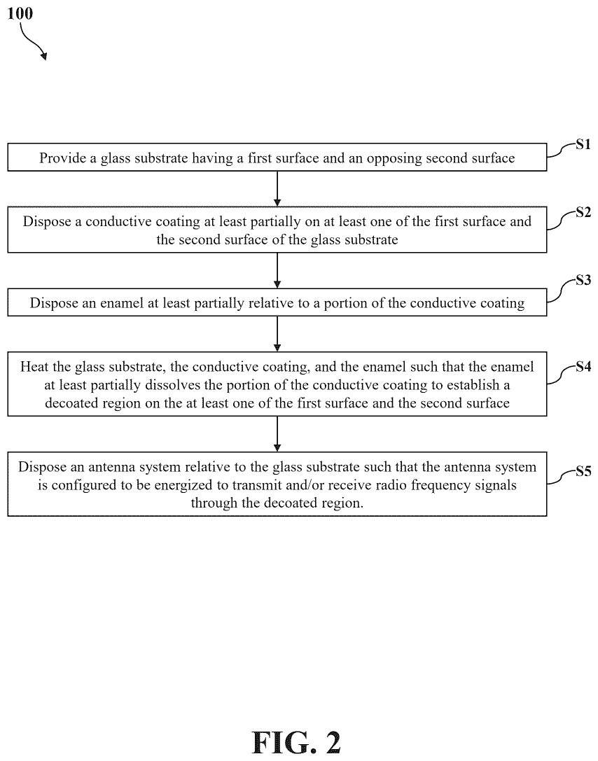

Referring to FIG. 2, a method 100 according to the present disclosure generally includes the steps of: step S1 of providing a glass substrate 22 having a first surface (P1) and an opposing second surface (P2), step S2 of disposing a conductive coating 24 at least partially on at least one of the first surface P1 and the second surface P2 of the glass substrate 22, step S3 of disposing an enamel 26 at least partially relative to a portion 25 of the conductive coating 24, step S4 of heating the glass substrate 22, the conductive coating 24, and the enamel 26 such that the enamel 26 at least partially dissolves the portion 25 of the conductive coating 24 to establish a decoated region DR on the at least one of the first surface P1 and the second surface P2 to permit transmission of radio frequency signals therethrough, and step S5 of disposing an antenna assembly 28 relative to the glass substrate 22 such that the antenna assembly 28 is configured to be energized to transmit and/or receive radio frequency signals through the decoated region DR. Further description of each of step S1, step S2, step S3, step S4, and step S5 is included below. It should also be appreciated in view of the description below that step S1, step S2, step S3, step S4, and step S5 do not necessarily have to be carried out in numerical order, and variations of the method 100 where step S1, step S2, step S3, step S4, and step S5 are carried out in a different order are contemplated.

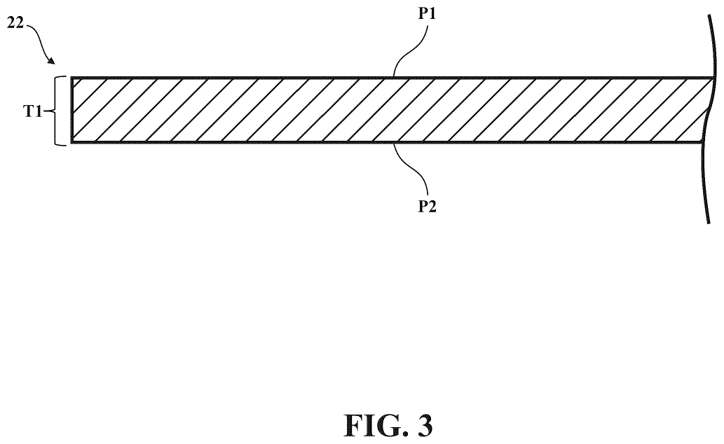

Referring to FIG. 3, step S1 of the method 100 includes providing a glass substrate 22 having a first surface P1 and an opposing second surface P2. As used herein, the first surface P1 may alternatively be referred to as the “P1 surface” and the second surface P2 may alternatively be referred to as the “P2 surface”. In examples where the glazing assembly 20 includes one glass substrate 22, the P2 surface is typically arranged to face the interior of the vehicle 18 or building 19 where the glazing assembly 20 is installed in the vehicle 18 or building 19, and accordingly the P1 surface is typically arranged to face outward from the vehicle 18 or building 19 where the glazing assembly 20 is installed in the vehicle 18 or building 19. Examples of systems 16 according to the present disclosure which include laminated glazing assemblies 120 including multiple glass substrates and variations of the method 100 related to such laminated glazing assemblies 120 are described in further detail below.

With continued reference to FIG. 3, the glass substrate 22 is typically provided as a flat glass sheet produced using any suitable flat glass manufacturing process including, but not limited to, a float process. The glass substrate 22 may be comprised of any suitable glass composition including, but not limited to, soda-lime glass, aluminosilicate glass, borosilicate glass, boro-aluminosilicate glass, and the like. As described in further detail below, although not required, the glass substrate 22 may be bent (e.g. during step S4 of the method 100, or via a separate bending process) such that the glass substrate 22 is curved. The glass substrate 22 may be bent using any suitable glass bending process including, but not limited to, press bending, gravity bending (i.e., sag bending), roll forming, or cold bending. The glass substrate 22 may be bent into any geometry suitable for the desired application. The glass substrate 22 may be thermally and/or chemically tempered or otherwise heat treated.

In some examples, the glass substrate 22 is transparent. In this context, the term “transparent”, also referred to as “substantially transparent”, refers to a material that allows 70% or more of light transmission in a predefined visible light range to travel therethrough. Unless otherwise indicated, the predefined visible light range is the segment of the electromagnetic spectrum that the human eye can view. More simply, this range of wavelengths is called visible light. Typically, the human eye can detect wavelengths from about 380 to about 780 nanometers, and thus the predefined visible light range as defined herein refers to wavelengths of light from about 380 to about 780 nanometers unless otherwise indicated. In some examples, the glass substrate 22 includes various additives to alter the transmissivity of the glass substrate 22. For example, additives may provide various levels of tint or coloration while still maintaining the glass substrate 22 as “transparent” or “substantially transparent” as described above. In other examples, the glass substrate 22 is less transparent than described above. For example, where the glazing assembly 20 is a privacy glass, the transparency of the glass substrate 22 may be substantially reduced, and thus the glazing assembly 20 allows less than 70% light transmission in a predefined wavelength range, such as from greater than 0 to 70% light transmission at the predefined wavelength range. For examples where the glazing assembly 20 is less transparent than described above, the glass substrate 22 may include various additives to reduce the transmissivity of the glass substrate 22 and/or the glazing assembly 20 may further include a transmissivity-altering coating or functional layer disposed relative to glass substrate 22 to alter the transmissivity of the glazing assembly 20 as a whole.

The glass substrate 22 has a thickness T1. The thickness T1 of the glass substrate 22 may be any suitable thickness for the application. For example, in vehicle applications, the thickness T1 of the glass substrate 22 may typically be from about 0.3 mm to about 5.0 mm. More specifically, the thickness T1 may be about 0.3 mm, 0.4 mm, 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm. 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm, 3.0 mm, 3.1 mm, 3.2 mm, 3.3 mm, 3.4 mm, 3.5 mm, 3.6 mm, 3.7 mm, 3.8 mm, 3.9 mm, 4.0 mm, 4.1 mm, 4.2 mm, 4.3 mm, 4.4 mm, 4.5 mm, 4.6 mm, 4.7 mm, 4.8 mm, 4.9 mm, or 5.0 mm. For non-vehicle applications (e.g. building applications), the thickness T1 is typically from 3.0 mm to 12.0 mm, but other values for the thickness T1 are contemplated.

As described in further detail below, step S2 of the method 100 generally includes disposing the conductive coating 24 at least partially on at least one of the first surface P1 and the second surface P2 of the glass substrate 22, and step S3 of the method 100 generally includes disposing an enamel 26 at least partially relative to a portion 25 of the conductive coating 24. As used herein, the phrase “disposing the conductive coating 24 least partially on at least one of the first surface P1 and the second surface P2” refers to disposing the conductive coating 24 or some or all of the at least one of the first surface P1 and the second surface P2 and optionally disposing the conductive coating 24 on additional surfaces. For example, in some configurations, as described in further detail below, the conductive coating 24 is disposed over the enamel 26. As alluded to above, step S1, step S2, step S3, step S4, and step S5 do not necessarily have to be carried out in numerical order. Particularly, in some examples, the order of operations of step S2 and step S3 may be switched. Stated differently, in some examples, step S3 may be carried out before step S2. Accordingly, as used herein, the phrase “disposing an enamel 26 at least partially relative to a portion 25 of the conductive coating 24” refers to disposing the enamel 26 over one of the glass substrate 22 or the conductive coating 24 (depending on the order of operations of step S2 and S3, as described in further detail below) such that the enamel 26 is disposed adjacent to the portion 25 of the conductive coating 24 and optionally disposing the enamel 26 on additional surfaces.

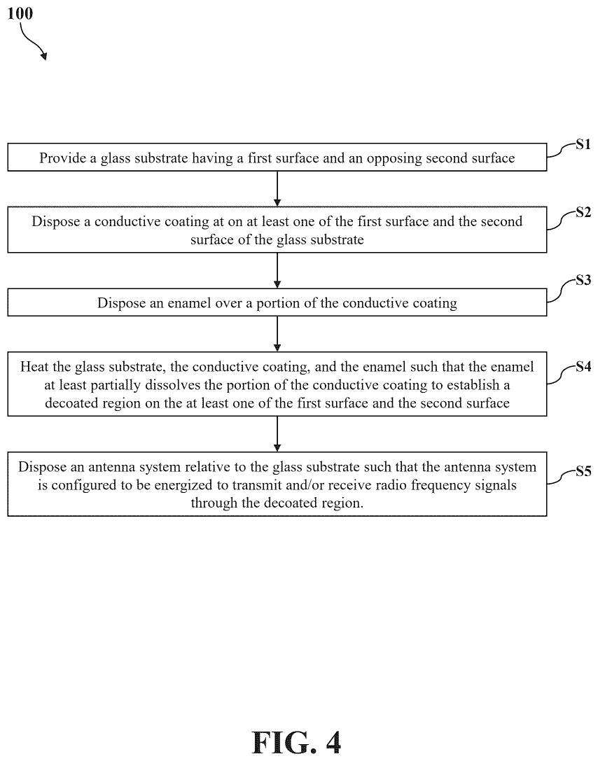

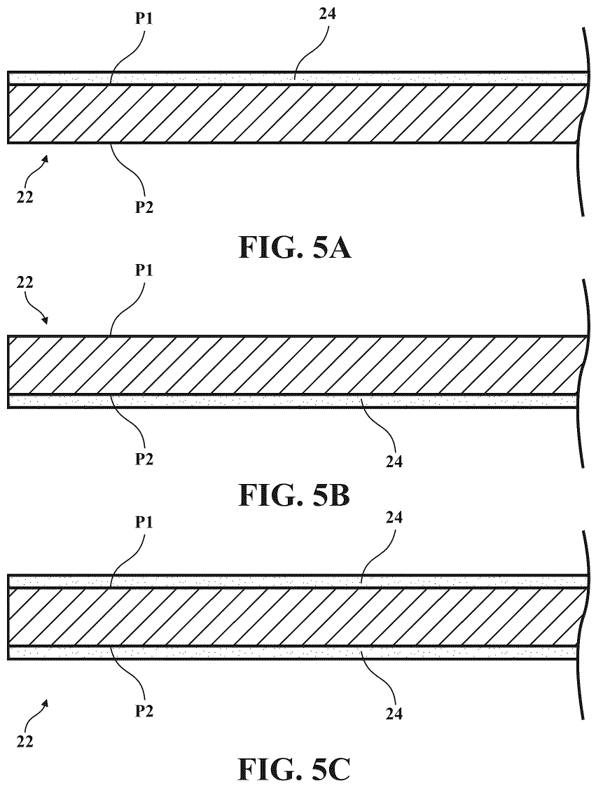

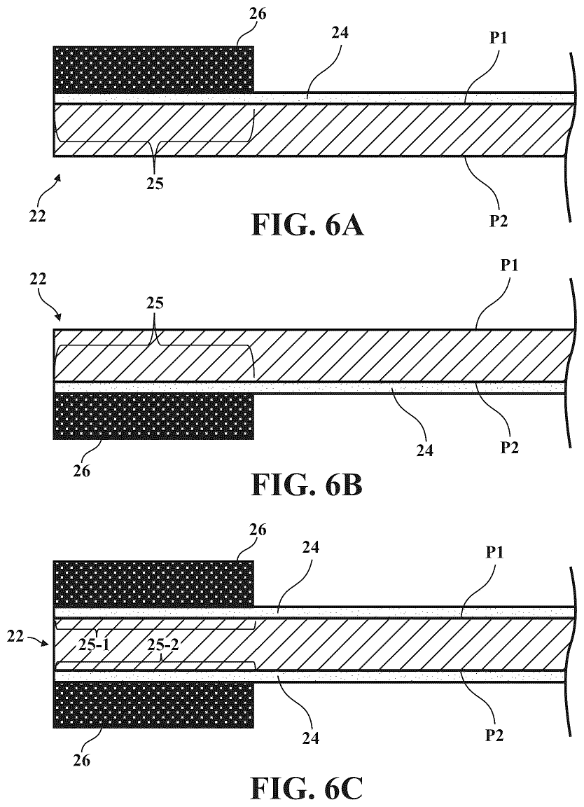

FIGS. 4-6C illustrate an example of the method 100 according to the present disclosure where step S2 is carried out before step S3. Particularly, as shown in the flowchart of FIG. 4, where step S2 is carried out before step S3, step S2 includes disposing the conductive coating 24 on at least one of the first surface P1 and the second surface P2 of the glass substrate 22 (shown in FIGS. 5A-5C), and step S3 includes disposing the enamel 26 over a portion 25 of the conductive coating 24 (shown in FIGS. 6A-6C). Referring to FIGS. 5A-5C, in these examples, step S2 typically includes disposing the conductive coating 24 on the entirety of the at least one of the first surface P1 and the second surface P2 of the glass substrate 22. Advantageously, by disposing the conductive coating 24 on the entirety of the at least one of the first surface P1 and the second surface P2, issues associated partially disposing the conductive coating 24 on the glass substrate 22 (e.g. suboptimal uniformity of the conductive coating 24, uneven heating of the glass substrate 22 during bending, visibility of the edge of the conductive coating 24) are eliminated. As best shown in FIG. 6A-6C, in these examples, the enamel 26 is disposed over the portion 25 of the conductive coating 24 such that the portion 25 of the conductive coating 24 is between the enamel 26 and the glass substrate 22.

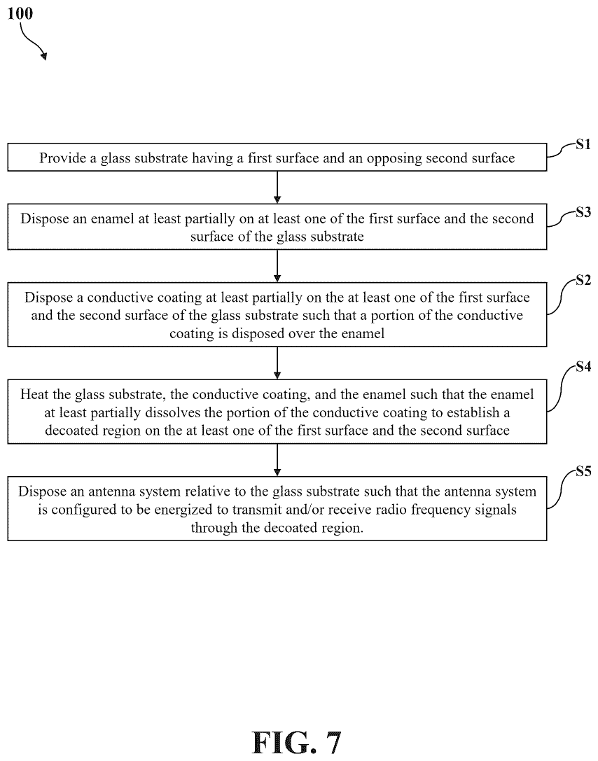

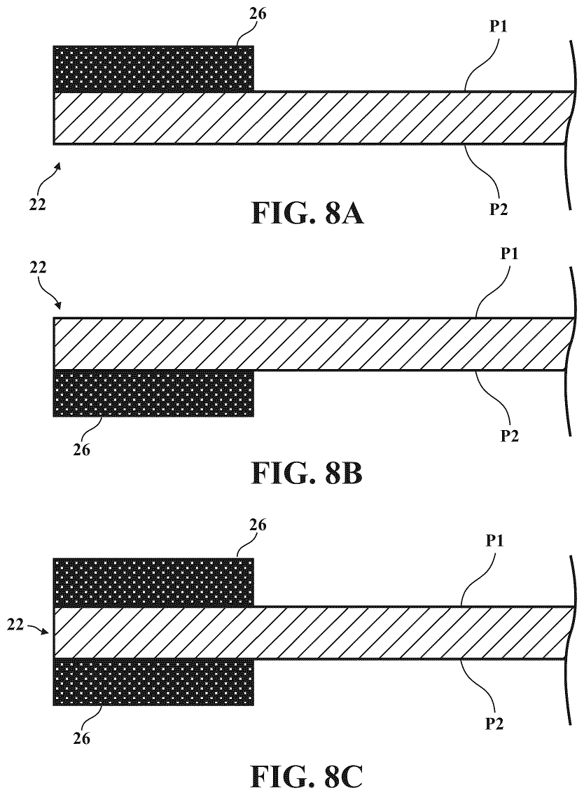

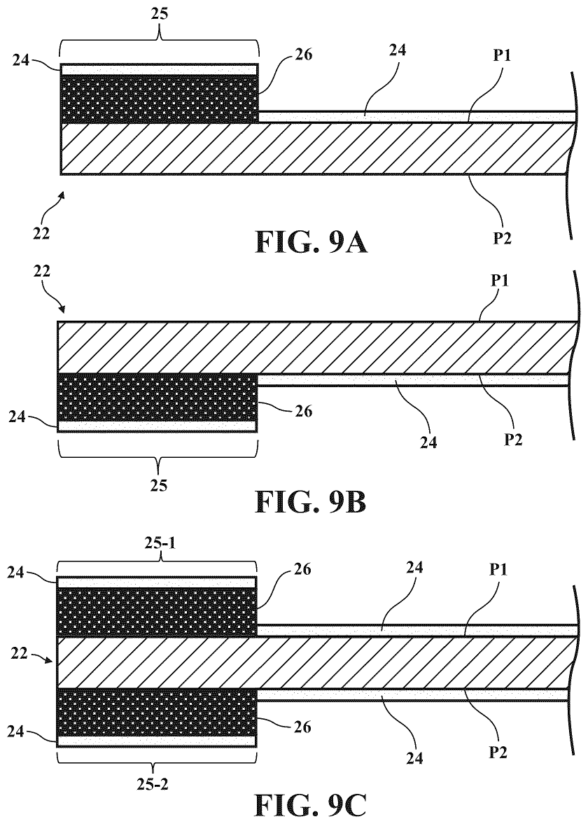

FIGS. 7-9C illustrate an example of the method 100 according to the present disclosure where step S3 is carried out before step S2. Particularly, as shown in the flowchart of FIG. 7, where step S3 is carried out before step S2, step S3 includes first disposing an enamel 26 at least partially on at least one of the first surface P1 and the second surface P2 of the glass substrate 22. Step S2 (in this case, carried out after step S3) includes disposing a conductive coating 24 at least partially on the at least one of the first surface P1 and the second surface P2 of the glass substrate 22 such that the enamel 26 is disposed relative to a portion 25 of the conductive coating 24 (e.g. the portion 25 of the conductive coating 24 is disposed over the enamel 26). Referring to FIGS. 8A-8C, in this example, the enamel 26 is first disposed on the glass substrate 22 in the pattern desired to establish the decoated region DR and dried to solidify the enamel 26. Next, referring to FIGS. 9A-9C, the conductive coating 24 subsequently at least partially disposed on the at least one of the first surface P1 and the second surface P2 of the glass substrate 22, with the portion 25 of the conductive coating 24 disposed over the enamel 26. Here, the portion 25 of the conductive coating 24 is disposed over the enamel 26 such that the enamel 26 is between the portion 25 of the conductive coating 24 and the glass substrate 22.

It should be appreciated that regardless of the order of carrying out step S2 and step S3, the enamel 26 will be adjacent to the portion 25 of the conductive coating 24 such that, as described in further detail below in the context of step S4, when subjected to heat, the enamel 26 at least partially dissolves the portion 25 of the conductive coating 24 relative to which the enamel 26 is disposed to establish the decoated region DR. Additional details regarding specific details of step S2 and step S3 are described in further detail below.

Referring to FIGS. 5A-5C and 9A-9C, step S2 of the method 100 includes disposing a conductive coating 24 at least partially on at least one of the first surface P1 and the second surface P2 of the glass substrate 22. In other words, the conductive coating 24 may be at least partially disposed on only P1 surface (as shown in FIGS. 5A and 9A), at least partially disposed on only the P2 surface (as shown in FIGS. 5B and 9B), or at least partially disposed on both the P1 surface and the P2 surface (as shown in FIGS. 5C and 9C). The conductive coating 24 may be at least partially disposed on the at least one of the first surface P1 and the second surface P2 of the glass substrate 22 using any suitable deposition process such as physical vapor deposition, sputtering, chemical vapor deposition, or the like. In certain embodiments, the conductive coating 24 is deposited onto the glass substrate 22 to a thickness ranging from 5 to 500 nanometers (i.e., 0.005 to 0.5 microns). It should be appreciated that the layers of the glazing assembly 20 shown throughout the cross-sectional representations in the Figures are not necessarily to drawn to scale in the thickness direction for illustrative purposes.

Although not required, the conductive coating 24 may comprise at least one of a metal, a transparent conductive oxide or a transparent conductive nitride. Where the conductive coating 24 comprises a metal, the metal may include silver, copper, aluminum, other conductive metals, or alloys thereof. Where the conductive coating 24 may comprise a transparent conductive oxide, the transparent conductive oxide may include a tin oxide, a silver oxide, a zinc oxide, or the like. Where the conductive coating 24 comprises a transparent conductive nitride, the transparent conductive nitride may comprise titanium nitride, tantalum nitride, or the like. In some examples, the conductive coating 24 may be a first conductive coating 24A having a first composition and disposed on one of the P1 surface and the P2 surface of the glass substrate 22, and a second conductive coating 24B having a second composition, different from the first composition, may be disposed on the other of the P1 surface and the P2 surface of the glass substrate 22.

The conductive coating 24 may be at least partially transparent such that the conductive coating 24 allows at least some light transmission at the at the predefined wavelength range therethrough. For applications where the glazing assembly 20 is a windshield, the conductive coating 24 may be substantially transparent (as defined above) such that the glazing assembly 20 is also substantially transparent. Where the conductive coating 24 includes a transparent conductive oxide and/or a transparent conductive nitride, the transparent conductive oxide and/or the transparent conductive nitride may be doped with an additive, such as indium, aluminum, gallium, etc. Specifically, the additive may be included in the transparent conductive oxide and/or the transparent conductive nitride to optimize the light transmission and/or the electrical conductivity of the conductive coating 24.

In some examples, the conductive coating 24 consists of a single layer comprising metal, transparent conductive oxide, or transparent conductive nitride. In other examples, the conductive coating 24 is a multi-layer conductive coating 24. In such examples, multi-layer conductive coatings 24 may include one or more conductive layers comprised of metal, transparent conductive oxide, or a combination thereof (i.e., one or more layers of metal and one or more layers of transparent conductive oxide). These multi-layer conductive coatings 24 may further include one or more dielectric layers disposed adjacent to the glass substrate 22 and/or the conductive layer(s) to provide electrical isolation to the conductive layers and/or to protect the conductive layers from the surrounding environment. For example, these multi-layer conductive coatings 24 may include n conductive layers and n+1 dielectric layers, with n≥1, such that each conductive layer is disposed between two dielectric layers. The dielectric layer(s) may comprise oxides, nitrides, oxynitrides, or oxycarbides of Zn, Sn, Ti, Zr, Si, In, Al, Nb, Sb, Ni, Cr, V, Mb, Mg, the like, or combinations thereof. It should be appreciated that these multi-layer conductive coatings 24 may include additional functional layers, such as contact layers comprising a material such as an oxide and/or a nitride of nickel-chrome or any other suitable material. Other configurations of multi-layer conductive coatings 24 are contemplated.

In some examples, the conductive coating 24 is an infrared reflective coating. Where the conductive coating 24 is implemented as an infrared reflective coating, the conductive coating 24 functions to reflect infrared radiation while allowing transmission of visible light therethrough, thereby reducing solar heat gain through the glazing assembly 20. In some examples, the infrared reflective coating includes a plurality of conductive layers (e.g. silver) and a plurality of dielectric layers (e.g. silicon dioxide). In one configuration, the infrared reflective coating may include two conductive layers and three dielectric layers, disposed in the following sequence relative to the glass substrate 22: 1) dielectric layer, 2) conductive layer, 3) dielectric layer, 4) conductive layer, 5) dielectric layer. In another configuration, the infrared reflective coating may include three conductive layers and four dielectric layers, disposed in the following sequence relative to the glass substrate 22: 1) dielectric layer, 2) conductive layer, 3) dielectric layer, 4) conductive layer, 5) dielectric layer, 6) conductive layer, 7) dielectric layer. One exemplary infrared reflective coating composition is the IRIS Neutral coating composition, commercially available from AGC Glass Europe, which is a complex stack of different thin metallic coatings (including various layers of metal oxides and silver), deposited onto the glass substrate 22 by a magnetron sputtering process. Other configurations of the conductive coating 24 realized as an infrared reflective coating are contemplated.

In other examples, the conductive coating 24 is a low emissivity coating. Where the conductive coating 24 is implemented as a low emissivity coating, the conductive coating 24 functions to block (i.e., reflect and/or absorb) certain amounts of infrared radiation and, in certain embodiments, is also configured to block certain amounts of ultraviolet UV radiation and prevent the same from transmitting through the glazing assembly 20. Exemplary low emissivity coating compositions include silver oxide compositions, indium tin oxide compositions, and silver-based compositions (single, double, and triple silver coating compositions). Other exemplary low emissivity coating compositions are described in U.S. Pat. No. 7,901,781, issued on Mar. 8, 2011 and assigned to AGC Flat Glass North America, Inc., and U.S. Pat. No. 9,709,717, issued on Jul. 18, 2017 and assigned to AGC Glass Europe, the contents of which are herein incorporated by reference in their entirety. Other configurations of the conductive coating 24 realized as a low emissivity coating are contemplated.

In some examples, the conductive coating 24 is a heatable coating configured to be energized to defrost and/or defog the glazing assembly 20. In these examples, composition and the deposition process of the conductive coating 24 are selected to have a suitable sheet resistance such that when the conductive coating 24 is energized, the conductive coating generates heat to defrost and/or defog the glazing assembly 20. One exemplary heatable coating is described in U.S. Pat. No. 6,670,581, issued on Dec. 30, 2003 and assigned to AGC Glass Europe SA, the contents of which is herein incorporated by reference in its entirety. Other configurations of the conductive coating 24 realized as a heatable coating are contemplated.

Notably, the conductive coating 24 inhibits transmission of radio frequency signals therethrough. Particularly, the conductive nature of the conductive coating 24 significantly attenuates transmission of radio frequency signals through the conductive coating 24. In other words, the metal, transparent conductive oxide, and/or transparent conductive nitride of the conductive coating 24 absorbs and/or reflects radio frequency signals, inhibiting the radio frequency signals from passing through the conductive coating 24. Typically, the conductive coating 24 is applied over the entire P1 surface and/or the entire P2 surface of the glass substrate 22. Accordingly, the conductive coating 24 typically inhibits transmission of radio frequency signals through the glazing assembly 20 as a whole. For example, an uncoated reference glass substrate has an average RF transmittance over a range of 1 GHz to 32 GHz of over 80%. A glass substrate 22 including a conductive coating 24 comprising indium tin oxide (a transparent conductive oxide) has average RF transmittance over a range of 1 GHz to 32 GHz of about 10% to 15%. Likewise, a glass substrate 22 including a conductive coating 24 comprising two or three silver layers has average RF transmittance over a range of 1 GHz to 32 GHz of less than 3%. Accordingly, there is a significant attenuation of RF transmittance through glazing assemblies including a glass substrate having a conductive coating disposed on a surface thereof. Thus, conventionally, antenna assemblies were not typically disposed relative to these coated glazing assemblies, or prohibitively expensive and/or labor intensive measures (e.g. laser ablation, mechanical decoating, etc.) were taken to selectively remove portions of these conductive coatings to permit transmission of radio frequency signals therethrough. As will be appreciated from the following description of steps S3, S4, and S5, the method 100 according to the present disclosure provides a significantly improved process (both from a cost and labor perspective) for selectively removing portions of the conductive coating 24 to permit transmission of radio frequency signals therethrough.

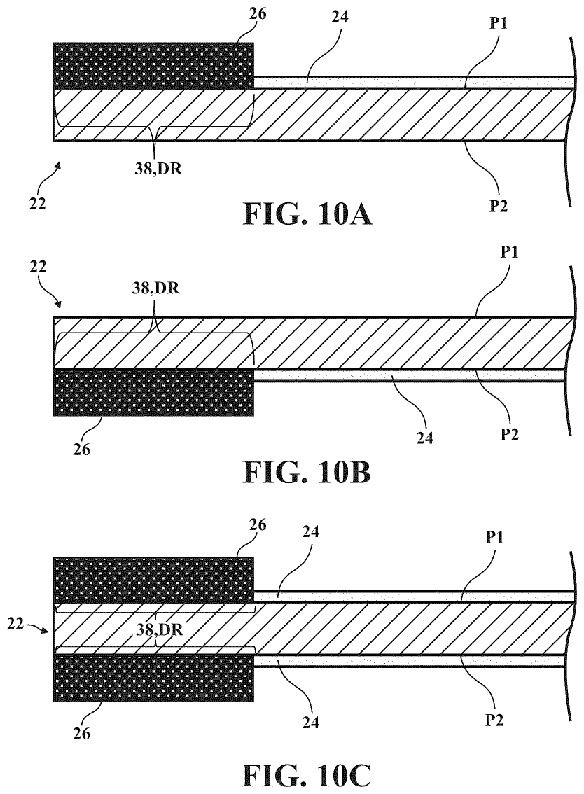

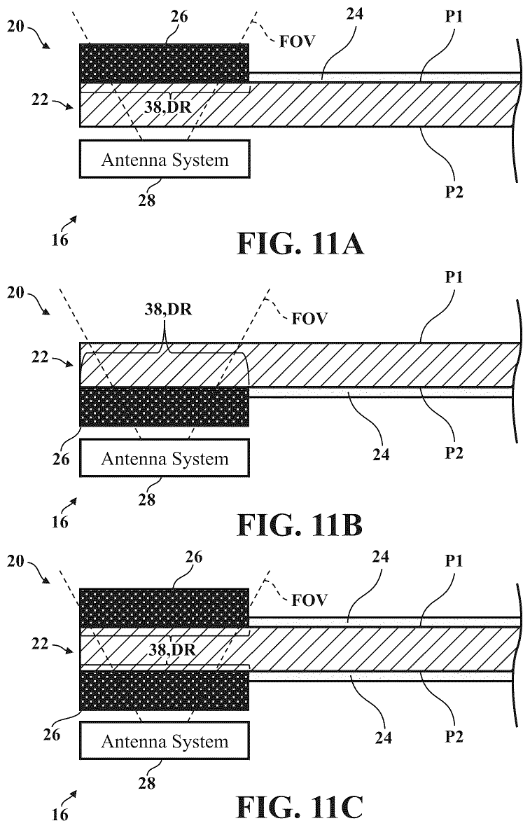

Referring to FIGS. 6A-6C and 8A-9C, step S3 of the method 100 includes disposing an enamel 26 at least partially relative to a portion 25 of the conductive coating 24. Here, the portion 25 of the conductive coating 24 relative to which the enamel 26 is disposed is a region of the conductive coating 24 where it is desired to establish a decoated region DR. As shown in FIGS. 6A-6C and 8A-9C, the enamel 26 is disposed in direct contact with (i.e., adjacent to) the portion 25 of the conductive coating 24. In the examples of FIGS. 6A-6C, the portion 25 of the conductive coating 24 is arranged between the enamel 26 and the glass substrate 22. In the examples of FIGS. 8A-9C, the enamel 26 is arranged between the portion 25 of the conductive coating 24 and the glass substrate 22. As discussed in further detail below in the context of step S4 and FIGS. 10A-10C, when subjected to heat, the enamel 26 at least partially dissolves the portion 25 of the conductive coating 24 relative to which the enamel 26 is disposed to establish the decoated region DR. As will be further appreciated in view of the description of step S5 and FIGS. 11A-11C, the decoated region DR permits transmission of radio frequency signals therethrough, and, thus, an antenna assembly 28 may be arranged relative to the glass substrate 22 to transmit and/or receive radio frequency signals through the decoated region DR.

Advantageously, because the enamel 26 at least partially dissolves the portion 25 of the conductive coating 24 to establish the decoated region DR (as opposed to another, separate process establishing the decoated region DR) the boundary between the enamel 26 and the remaining conductive coating 24 does not suffer from visible misalignments or gaps between the enamel 26 and the remaining conductive coating 24 experienced by conventional decoating processes.

As described above, FIGS. 6A-6C illustrate examples of the method 100 where step S2 is carried out before step S3. Here, referring to FIG. 6A, in examples where the conductive coating 24 is at least partially disposed on only the P1 surface of the glass substrate 22, the enamel 26 is at least partially disposed over the portion 25 of the conductive coating 24 such that the portion 25 of the conductive coating 24 is arranged between the enamel 26 and the P1 surface of the glass substrate 22. Referring to FIG. 6B, in examples where the conductive coating 24 is at least partially disposed on only the P2 surface of the glass substrate 22, the enamel 26 is at least partially disposed over the portion 25 of the conductive coating 24 such that the portion 25 of the conductive coating 24 is arranged between the enamel 26 and the P2 surface of the glass substrate 22. Referring to FIG. 6C, in examples where the conductive coating 24 is at least partially disposed on both the P1 surface and the P2 surface of the glass substrate 22, the portion 25 of the conductive coating 24 over which the enamel 26 is at least partially disposed includes a first sub-portion 25-1 and a second sub-portion 25-2. The first sub-portion 25-1 is a portion 25 of the conductive coating 24 at least partially disposed on the P1 surface of the glass substrate 22 such that the first sub-portion 25-1 of the conductive coating 24 is arranged between the enamel 26 and the P1 surface of the glass substrate 22, and the second sub-portion 25-2 is a portion 25 of the conductive coating 24 at least partially disposed on the P2 surface of the glass substrate 22 such that the second sub-portion 25-2 of the conductive coating 24 is arranged between the enamel 26 and the P2 surface of the glass substrate 22. In these examples, as described in further detail below, the first sub-portion 25-1 and the second sub-portion 25-2 typically at least partially overlap each other such that the decoated region DR established by the enamel 26 permits transmission of radio frequency signals through both the conductive coating 24 disposed on P1 surface and the conductive coating 24 disposed on the P2 surface.

As described above, FIGS. 8A-9C illustrate examples of the method 100 where step S3 is carried out before step S2. Here, referring to FIG. 9A, in examples where the conductive coating 24 is at least partially disposed on only the P1 surface of the glass substrate 22, the enamel 26 is at least partially disposed relative to the portion 25 of the conductive coating 24 such that the enamel 26 is arranged between the portion 25 of the conductive coating 24 and the P1 surface of the glass substrate 22. Referring to FIG. 9B, in examples where the conductive coating 24 is at least partially disposed on only the P2 surface of the glass substrate 22, the enamel 26 is at least partially disposed relative to the portion 25 of the conductive coating 24 such that the enamel 26 is arranged between portion 25 of the conductive coating 24 and the P2 surface of the glass substrate 22. Referring to FIG. 9C, in examples where the conductive coating 24 is at least partially disposed on both the P1 surface and the P2 surface of the glass substrate 22, the portion 25 of the conductive coating 24 relative to which the enamel 26 is at least partially disposed includes a first sub-portion 25-1 and a second sub-portion 25-2. The first sub-portion 25-1 is a portion 25 of the conductive coating 24 at least partially disposed over the enamel 26 such that the enamel 26 is arranged between the first sub-portion 25-1 of the conductive coating 24 and the P1 surface of the glass substrate 22, and the second sub-portion 25-2 is a portion 25 of the conductive coating 24 at least partially disposed over the enamel 26 such that the enamel 26 is arranged between the second sub-portion 25-2 of the conductive coating 24 and the P2 surface of the glass substrate 22. In these examples, as described in further detail below, the first sub-portion 25-1 and the second sub-portion 25-2 typically at least partially overlap each other such that the decoated region DR established by the enamel 26 permits transmission of radio frequency signals through both the conductive coating 24 disposed on P1 surface and the conductive coating 24 disposed on the P2 surface.

The enamel 26 is typically an ink or paste that is disposed relative to the portion 25 of the conductive coating 24 (or the glass substrate 22 where step S3 is carried out before step S2) by screen printing, digital printing, etc. The enamel 26 typically includes a frit mixture, a pigment, and a vehicle. The frit mixture of the enamel 26 is generally configured to melt or soften when subjected to heat such that the enamel 26 fuses to the glass substrate 22. Furthermore, the enamel 26 is generally comprised of a composition or includes additives which, when subjected to heat, chemically interact with the adjacent portion 25 of the conductive coating 24 to at least partially dissolve the portion 25 of the conductive coating 24 relative to which the enamel 26 is disposed to establish the decoated region DR. The pigment of the enamel 26 is typically an inorganic pigment (e.g. iron oxide, cobalt oxide, copper chromite, manganese oxide, nickel oxide, the like, or combinations thereof) for imparting a black color and opacity to the enamel 26, particularly once the enamel 26 has been subject to the heating from step S4. The frit mixture and/or the pigment of the enamel 26 may include particular oxides (e.g. Bi₂O₃, B₂O₃, ZnO, SiO₂, SrO, SnO₂, Al₂O₃, MgO, MnO, MnO₂, K₂O, BaO, CeO₂, Na₂O, Li₂O, TiO₂, TeO₂, PbO, Fe₂O₃, Co₃O₄, Cr₂O₃, the like, and combinations thereof) which, when subjected to heat, migrate toward the adjacent portion 25 of the conductive coating 24 and chemically interact with the adjacent portion 25 of the conductive coating 24 to at least partially dissolve the adjacent portion 25 of the conductive coating 24 relative to which the enamel 26 is disposed. For example, the oxides of the frit mixture and/or the pigment of the enamel 26 chemically interact with the conductive components of the conductive coating 24 to at least partially dissolve the adjacent portion 25 of the conductive coating 24 (thus establishing the decoated region DR) such that the at least partially dissolved portion 25 of the conductive coating 24 has reduced conductivity (described in further detail below), thereby permitting transmission of radio frequency signals through the decoated region DR. Furthermore, the chemical interaction between the oxides of the frit mixture and/or the pigment of the enamel 26 and the conductive components of the conductive coating 24 may inhibit the oxidation-reduction reaction typically experienced by the conductive coating 24, thereby preventing discoloration of the conductive coating 24. The vehicle of the enamel 26 is typically an organic vehicle such as an oil, an alcohol, or other solvent that is configured to evaporate when subjected to heat.

In one example, the enamel 26 may comprise i) 10 to 40 mol % ZnO, ii) 20 to 40 mol % B₂O₃, iii) 25 to 65 mol % Bi₂O₃, TeO₂, or PbO, or mixtures thereof, and iv) 0.1 to 15 mol % Al₂O₃. In some examples, the enamel 26 may further comprise (v) 0 to 10 mol % of one or more compounds selected from Li₂O, Na₂O, and K₂O, (vi) 0 to 10 mol % of one or more compounds selected from MgO, CaO, SrO, and SnO₂, (vii) 0 to 2 mol % CeO₂, (viii) 0 to 10 mol SiO₂, and (ix) incidental impurities. In another example, the enamel 26 may comprise i) 20 to 25 mol % ZnO (e.g. 23.3 mol % ZnO), (ii) 24 to 28 mol % B₂O₃ (e.g. 26.0 mol % B₂O₃), (iii) 40 to 45 mol % Bi₂O₃ (e.g. 43.7 mol % Bi₂O₃), (iv) 6.0 to 8.0 mol % Al₂O₃ (e.g. 7.0 mol % Al₂O₃); and (v) incidental impurities. In a further example, the enamel 26 may comprise i) about 1 to about 10 mol % Li₂O, ii) about 3 to about 15 mol % Na₂O, iii) about 20 to about 65 mol % SiO₂, iv) about 1 to about 40 mol % B₂O₃, about 0.1 to about 3 mol % Al₂O₃, v) about 0.1 to about 16 mol % TiO₂, vi) about 2.3 to about 17.8 mol % Fe₂O₃, about 2.2 to about 6.1 mol % MnO₂, and vii) about 1.2 to about 2.4 mol % Co₃O₄. Exemplary compositions of the enamel 26 are described in U.S. Patent App. Pub. No. 2022/0227661, published on Jul. 21, 2022 and assigned to Fenzi AGT Netherlands BV; and U.S. Patent App. Pub. No. 2022/0234942, published on Jul. 28, 2022 and assigned to Vibrantz Corporation, the contents of which are herein incorporated by reference in their entirety. Other compositions of the enamel 26 suitable for at least partially dissolving the portion 25 of the conductive coating 24 relative to which the enamel 26 is disposed when subjected to heat are contemplated.

The enamel 26 is typically black and opaque and thus the enamel 26 may, in addition to establishing the decoated region DR, serve to block transmission of light through the glazing assembly 20 in the region(s) where the enamel 26 is disposed. In other words, the enamel 26, particularly once subjected to step S4, has an opacity. In this context, opacity refers to an average transmission of visible light through a sample area of the enamel 26. The opacity of the enamel 26 may be measured using a light transmittance meter (for example, according to ISO 9050 and/or ISO 13837) to determine the amount of light that the enamel 26 absorbs, scatters, and/or reflects. In one example, the enamel 26 may have an opacity of less than 1% transmission of visible light, or even less than 0.1% transmission of visible light. Furthermore, in some configurations, as described in further detail below, the enamel 26 dissolves most of, it not all of, the conductive coating 24 such that the decoated region DR is substantially free of the conductive coating 24. In these configurations, the enamel 26 may substantially reduce or eliminate the discoloration issues associated with disposing a conventional black ceramic enamel relative to the conductive coating 24. For example, the enamel 26 disposed relative to the conductive coating 24 may impart a black color having a delta E color shift relative to a reference uncoated glass substrate with conventional black ceramic enamel and/or a predefined black reference color of between 0 and 2, more preferably between 0 and 1.75, and still more preferably between 0 and 1.5. Additionally or alternatively, the black color of the enamel 26 may be quantified in terms of L* color value, a* color value, and/or b* color value. There are two ways to measure L*: specular included and specular excluded. The black color of the enamel 26 may have a specular included L* value of between about +22 and −22. The black color of the enamel 26 may additionally or alternatively have a specular excluded L* value of between about +10 and −10, between about +7.5 and −7.5, between about +5 and −5, etc. Furthermore, the enamel 26 may have an a* color value of between about +2.5 and −2.5, between about +1 and −1, etc. The enamel 26 may additionally or alternatively have a b* color value of between about +3.5 and −3.5, between about +2 and −2, between about +1 and −1, etc.

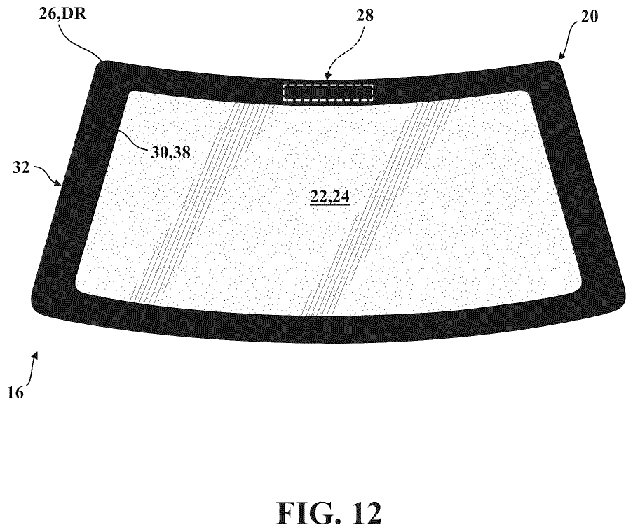

Referring to FIG. 12, in some examples, the portion 25 of the conductive coating 24 relative to which the enamel 26 is disposed is defined such that the enamel 26 is formed as a band 30 extending around a peripheral edge 32 of the glazing assembly 20. In these examples, the band 30 blocks transmission of light through the region of the glazing assembly 20 extending around the peripheral edge 32. In doing so, the band 30 prevents UV light from deteriorating an adjacent adhesive that may bond the glazing assembly 20 to the vehicle 18 or building 19, and blocks visibility of the adjacent adhesive to an outside observer, providing an improved aesthetic exterior appearance.

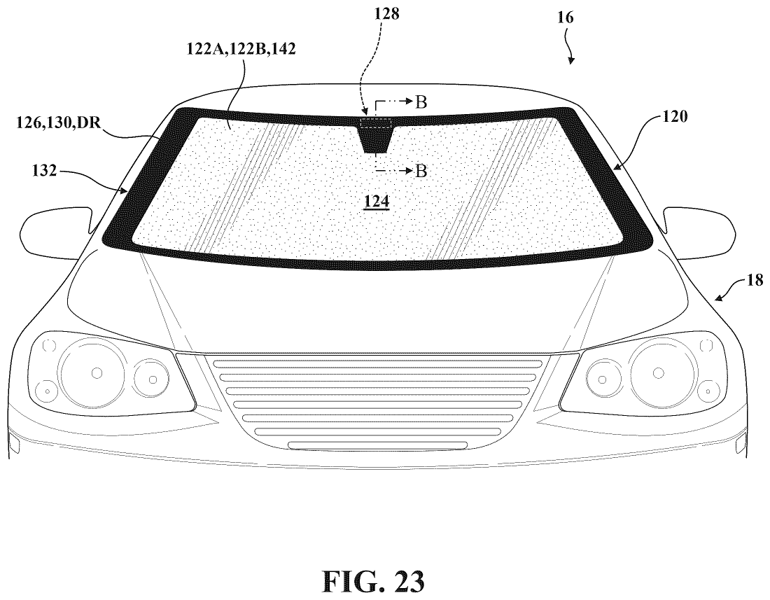

In some examples, as described in further detail below, the antenna assembly 28 is disposed beneath the band 30 such that the antenna assembly 28 may transmit and/or receive radio frequency signals through the decoated region DR defined by the band 30. In some configurations, the portion 25 of the conductive coating 24 relative to which the enamel 26 is disposed is defined such that the band 30 includes peninsula regions (see e.g. FIG. 23) extending inward from the peripheral edge 32 of the glazing assembly 20 to provide additional surface area beneath which the antenna assembly 28 may be disposed and/or to shield other components coupled to the glazing assembly 20, such as brackets supporting a rearview mirror, sensors such as cameras, etc. It should also be appreciated that the portion 25 of the conductive coating 24 relative to which the enamel 26 is disposed may additionally or alternatively define standalone regions (i.e., regions spaced from peripheral edge 32 of the glazing assembly 20 and not connected to the band 30) beneath which the antenna assembly 28 may be disposed. Stated differently, in some configurations, the portion 25 relative to which the enamel 26 is disposed is a single contiguous region, but in other configurations, the portion 25 relative to which the enamel 26 is disposed may be a plurality of portions 25 which are not connected and establish a plurality of decoated regions DR. Other geometric arrangements of disposing the enamel 26 are contemplated.

Referring to FIGS. 10A-10C, step S4 of the method 100 includes heating the glass substrate 22, the conductive coating 24, and the enamel 26 such that the enamel 26 at least partially dissolves the portion 25 of the conductive coating 24 to establish a decoated region DR on the at least one of the P1 surface and the P2 surface of the glass substrate 22 which include the conductive coating 24. Typically, step S4 involves disposing the glass substrate 22 with the conductive coating 24 disposed on the glass substrate 22, and with the enamel 26 disposed over the portion 25 of the conductive coating 24, in an oven suitable for heating glazing assemblies at a specific firing temperature for a predetermined time period. The firing temperature may be from 550° C. to 700° C. More specifically, the firing temperature may be 550° C., 555° C., 560° C., 565° C., 570° C., 575° C., 580° C., 585° C., 590° C., 595° C., 600° C., 605° C., 610° C., 615° C., 620° C., 625° C., 630° C., 635° C., 640° C., 645° C., 650° C., 655° C., 660° C., 665° C., 670° C., 675° C., 680° C., 685° C., 690° C., 695° C., or 700° C. All values therebetween and additional suitable firing temperatures are contemplated. The predetermined time period may be any time period sufficient for the enamel 26 to undergo the chemical interaction with the adjacent portion 25 of the conductive coating 24 such that the enamel 26 at least partially dissolves the adjacent portion of the conductive coating 24 to establish the decoated region DR. For example, the predetermined time period may be 5 minutes, 10 minutes, 15 minutes, 20 minutes, 25 minutes, 30 minutes, etc. All values therebetween and additional suitable predetermined time periods are contemplated. Optionally, before step S4, the enamel 26 may be subjected to a drying step at a lower temperature (e.g. from 100° C. to 150° C.) to dry the enamel 26 (e.g. to evaporate of some or all of the vehicle of the enamel 26, leaving behind just the frit mixture and the pigment of the enamel 26). Advantegously, because there are not coated and decoated regions of conductive coating 24 at the onset of step S4 (which would are known to cause differential heating issues), the glazing assembly 20 has a relatively uniform heat absorption profile, and thus issues with optical distortion associated with conventional processes are minimized.

In some examples, step S4 is undertaken as an independent step in the process of manufacturing the glazing assembly 20 at a firing temperature below the softening point temperature of the glass substrate 22. In other examples, Step S4 is undertaken as in conjunction with a step of bending the glass substrate 22 (i.e., at a firing temperature above the softening point temperature of the glass substrate 22). The glass substrate 22 may be bent using any suitable glass bending process including, but not limited to, press bending, gravity bending (i.e., sag bending), roll forming, and the like. The glass substrate 22 may be bent into any geometry suitable for the desired application.

As a result of the enamel 26 being heated in step S4, the enamel 26 at least partially dissolves the adjacent portion 25 of the conductive coating 24 to establish the decoated region DR to permit transmission of radio frequency signals therethrough. Here, the phase “at least partially dissolves” refers to the enamel 26 dissolving some or all of the adjacent portion 25 of the conductive coating 24. In some examples, as a result of step S4, the decoated region DR is substantially free of the conductive coating 24. As used herein, the phrase “substantially free of the conductive coating” refer to dissolution of most of, it not all of, the conductive coating 24 via the enamel 26 to establish the decoated region DR. For example, as a result of step S4, the enamel 26 may dissolve at least 90% of the portion 25 of the conductive coating 24 to establish the decoated region DR, at least 95% of the portion 25 of the conductive coating 24 to establish the decoated region DR, at least 99% of the portion 25 of the conductive coating 24 to establish the decoated region DR, or even 100% of the portion 25 of the conductive coating 24 to establish the decoated region DR. Where step S4 dissolves 100% of the portion 25 of the conductive coating 24 to establish the decoated region DR, the decoated region DR can be referred to as entirely free of the conductive coating 24. Additionally or alternatively, the conductive coating 24 may have a first conductivity and, as a result of step S4, the decoated region DR may have a second conductivity that is less than the first conductivity of the conductive coating 24 to permit transmission of radio frequency signals therethrough. Stated differently, as a result of step S4, the decoated region DR established via the enamel 26 may lose some of, if not all of, its conductivity such that the decoated region DR is less conductive than the conductive coating 24, thereby permitting transmission of radio frequency signals through the decoated region DR. For example, the decoated region DR may be 90% less conductive than the conductive coating 24, 95% less conductive than conductive coating 24, 99% less conductive than the conductive coating 24, or even 100% less conductive than the conductive coating 24. The conductivity of the conductive coating 24 and the decoated region may be measured, for example, using an inductive measuring device like the Stratometer from Nagy Instruments. It should be appreciated that, in some configurations, step S4 may not completely dissolve the conductive coating 24. Rather, step S4 may at least partially dissolve the portion 25 of the conductive coating 24 to establish the decoated region DR having reduced conductivity (as described above) to permit transmission of radio frequency signals therethrough, but inspection of the decoated region DR may reveal residual conductive coating 24 within the decoated region DR.

The decoated region DR may have average RF transmittance over a range of 1 GHz to 32 GHz of over 75%, exhibiting minimal RF transmittance attenuation compared to reference uncoated glass substrates. Table 1 below provides comparative examples of the average RF transmittance over a range of 1 GHz to 32 GHz of a reference uncoated glass substrate with a number of samples of glass substrates 22 with various conductive coatings 24 disposed thereon, as well as the average RF transmittance over a range of 1 GHz to 32 GHz of a decoated region DR established via the enamel 26 of each sample. In Table 1 below, Coated Substrate 1 is a glass substrate 22 with a conductive coating 24 comprising three layers of silver disposed thereon. Coated Substrate 2 is a glass substrate 22 with a conductive coating 24 comprising two layers of silver disposed thereon. Coated Substrate 3 is a glass substrate 22 with a conductive coating 24 comprising a first formulation of an ITO based coating disposed thereon. Coated Substrate 4 is a glass substrate 22 with a conductive coating 24 comprising a second formulation of an ITO based coating disposed thereon. The column entitled “Average RF Transmittance (%)” represents the average RF transmittance over a range of 1 GHz to 32 GHz through a region including the conductive coating 24 (where included) of each sample. The column entitled “Average RF Transmittance of Decoated Region (%)” represents the average RF transmittance over a range of 1 GHz to 32 GHz through the decoated region DR established via the enamel 26 of each sample.

TABLE 1

| | Average RF | Average RF |
|---|---|---|
| | Transmittance | Transmittance of |
| Sample | (%) | Decoated Region (%) |
| Uncoated Glass Substrate | 81.1% | — |
| Coated Substrate 1 | <2.4% | 78.1% |
| Coated Substrate 2 | 2.3% | 81.0% |
| Coated Substrate 3 | 13.3% | 80.0% |
| Coated Substrate 4 | 10.0% | 77.8% |

As can be seen from the comparative examples of Table 1, the decoated region DR established via the enamel 26 exhibits minimal RF transmittance attenuation compared to uncoated glass substrates. Thus, advantageously, antenna assemblies 28 may transmit and/or receive radio frequency signals through the decoated region DR without the need for prohibitively expensive and/or labor intensive measures (e.g. laser ablation, mechanical decoating, dedicated chemical etching processes, etc.) to remove the conductive coating 24.

Step S5 of the method 100 includes disposing an antenna assembly 28 relative to the glass substrate 22 such that the antenna assembly 28 is configured to be energized to transmit and/or receive radio frequency signals through the decoated region DR. FIGS. 11A-11C schematically illustrate an antenna assembly 28 disposed relative to the glass substrate 22. As used herein, the phrase “disposed relative to the glass substrate 22” or “disposed relative to the glazing assembly 20” encompasses configurations where the antenna assembly 28 is coupled to the glass substrate 22 or the antenna assembly 28 is spaced from the glass substrate 22 (e.g. supported elsewhere in the vehicle 18 or building 19). As shown schematically in FIGS. 11A-11C, the antenna assembly 28 may be disposed relative to the P2 surface of the glass substrate 22, which faces the interior of the vehicle 18 or building 19 such that the antenna assembly 28 transmits and/or receives radio frequency signals through the decoated region DR and is shielded from the exterior of the vehicle 18 or building 19 by the glass substrate 22. Other configurations of disposing the antenna assembly 28 relative to the glass substrate 22 are contemplated.

A variety of configuration of the antenna assembly 28 configured to be energized to transmit and/or receive radio frequency signals through the decoated region DR are contemplated. The implementation of the antenna assembly 28 is not necessarily limited for the purposes of this disclosure and may generally include any antenna assembly configured to transmit and/or receive radiofrequency signals. In some configurations, the antenna assembly 28 may be a standalone assembly configured to be coupled to another device (e.g. a modem or the like) which energizes/operates the antenna assembly 28. In other configurations, the antenna assembly 28 may be incorporated within a device (e.g. a portable electronic device such as a cell phone, tablet, computer, etc.). Other configurations of the antenna assembly 28 are contemplated.

The antenna assembly 28 may generally include a radiating portion 34 and a feeding portion 36 coupled to the radiating portion 34 to energize the radiating portion 34 to transmit and/or receive radio frequency signals through the decoated region DR. The radiating portion 34 may be configured as an omnidirectional radiating portion 34 or a directional radiating portion 34. As used herein, “omnidirectional radiating portion 34” refers to a radiating portion 34 that transmits and/or receives radio frequency signals with substantially uniform gain in all directions in one plane, providing a substantially 360-degree coverage area. As used herein, “directional radiating portion 34” refers to a radiating portion 34 that transmits and/or receives radio frequency signals having a higher gain in a desired direction. In many configurations, it may be desirable to implement the radiating portion 34 as a directional radiating portion 34 with the directionality of the radiating portion 34 oriented through the decoated region DR. The configuration of the radiating portion 34 is not necessarily limited for the purposes of this disclosure and may include the radiating elements having a monopole configuration, dipole configuration, loop configuration, patch configuration, horn configuration, slot configuration, fractal configuration, the like, and combinations thereof. In some examples, the radiating portion 34 may include a single radiating element or an array of radiating elements. Where the radiating portion 34 includes an array of radiating elements, the array of radiating elements may be a passive array or an active/steerable array. The configuration of the feeding portion 36 is likewise not necessarily limited for the purposes of this disclosure and may include direct feeding configurations (e.g. coaxial or microstrip feeding configurations), indirect feeding configurations (e.g. capacitive feeding configurations), the like, or combinations thereof. For examples where the radiation portion 34 includes an array of radiating elements, the feeding portion may include a feeding network (e.g. series-fed, parallel-fed, or a hybrid thereof), and/or may include active feeding elements for steering the array of radiating elements. Other configurations of the radiating portion 34 and feeding portion 36 are contemplated. It should also be appreciated that the antenna assembly 28 may include additional components (e.g. ground planes, impedance matching structures, etc.).

The antenna assembly 28 may be configured to transmit and/or receive radio frequency signals having linear polarization (e.g. vertical polarization and/or horizontal polarization) and/or circular polarization through the decoated region DR. In some examples, the antenna assembly 28 is configured to transmit and/or receive radio signals having a frequency of from 540 kilohertz to 6 gigahertz. Accordingly, the antenna assembly 28 may be configured to transmit and/or receive radio signals within any of a number of standard “sub-6 gigahertz” frequencies/protocols including, but not limited to, amplitude modulation (AM), frequency modulation (FM), Digital Audio Broadcasting (DAB), Remote Keyless Entry (RKE), Digital television (DTV), Global Positioning System (GPS), other satellite communication based protocols (e.g. L-Band, S-band, and some C-Band frequencies, etc.), V2X (vehicle-to-everything), Wi-Fi, 2G cellular, 3G cellular, 4G cellular, and 5G cellular frequencies (more specifically, low-band and mid-band 5G cellular frequencies that are less than 6 gigahertz). The antenna assembly 28 may additionally or alternatively be configured to transmit and/or receive radio signals having a frequency greater than 6 gigahertz, such as high-band 5G cellular frequencies (i.e., millimeter wave 5G frequencies), other higher frequency satellite communication based protocols (e.g. some C-Band frequencies, X-band, Ku-band, Ka-band, etc.), and the like. It should be appreciated that the operating frequency of the antenna assembly 28 is not necessarily limited for the purposes of this disclosure and that the antenna assembly 28 may be operable on network protocols defined in the future (e.g., 6G cellular).

Referring to FIGS. 11A-12, the decoated region DR generally defines a perimeter 38 (best shown in FIG. 12). As used herein, the “perimeter 38” of the decoated region DR refers to the general footprint of the decoated region DR. The antenna assembly 28 may be disposed relative to the glazing assembly 20 such that at least a portion of the antenna assembly 28 (e.g. the radiating portion 34) is arranged within the perimeter 38 of the decoated region DR to transmit and/or receive radio frequency signals through the decoated region DR. As best shown schematically in FIGS. 11A-11C, especially in examples where the antenna assembly 28 includes a directional radiating portion 34, the antenna assembly 28 may have a field of view FOV defined by the directionality of the radiating portion 34, and the perimeter 38 of the decoated region DR may be defined such that the conductive coating 24 does not obstruct the field of view FOV of the antenna assembly 28. The field of view FOV of the antenna assembly 28 may be static, or the field of view FOV of the antenna assembly 28 may be adjustable (e.g. where the antenna assembly 28 includes an active/steerable radiating portion 34). In examples where the field of view FOV of the antenna assembly 28 is adjustable, the perimeter 38 of the decoated region DR may be defined such that the conductive coating 24 does not obstruct the field of view FOV of the antenna assembly 28 at any point within its adjustability. In examples where the antenna assembly 28 is disposed relative to the P2 surface and the decoated region DR is established on both the P1 surface and the P2 surface (e.g. FIG. 11C), the perimeter 38 of the decoated region DR on the P1 surface may be different than the perimeter 38 of the decoated region DR on the P2 surface to ensure that neither the conductive coating 24 on the P1 surface nor the conductive coating on the P2 surface obstruct the field of view FOV of the antenna assembly 28.

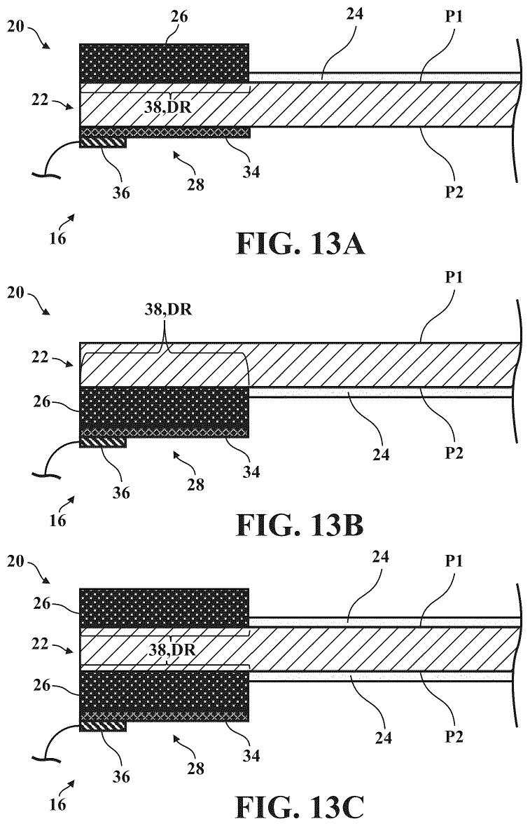

Schematic cross-sectional representations of system 18 according to the present disclosure taken along line A-A of FIG. 1 and including a variety of exemplary configurations of the antenna assembly 28 are shown in FIGS. 13A-16C. In each of the examples of FIGS. 13A-16C, the system 16 includes the glazing assembly 20 including the glass substrate 22 having the P1 surface and the P2 surface, the conductive coating 24 disposed on at least one of the P1 surface and the P2 surface which inhibits transmission of radio frequency signals therethrough, the enamel 26 disposed relative to a portion 25 of the conductive coating 24 to at least partially dissolve the portion 25 of the conductive coating 24 to establish a decoated region DR to permit transmission of radio frequency signals therethrough, and the antenna assembly 28 arranged relative to the glazing assembly 20 such that the antenna assembly 28 is configured to be energized to transmit and/or receive radio frequency signals through the decoated region DR.

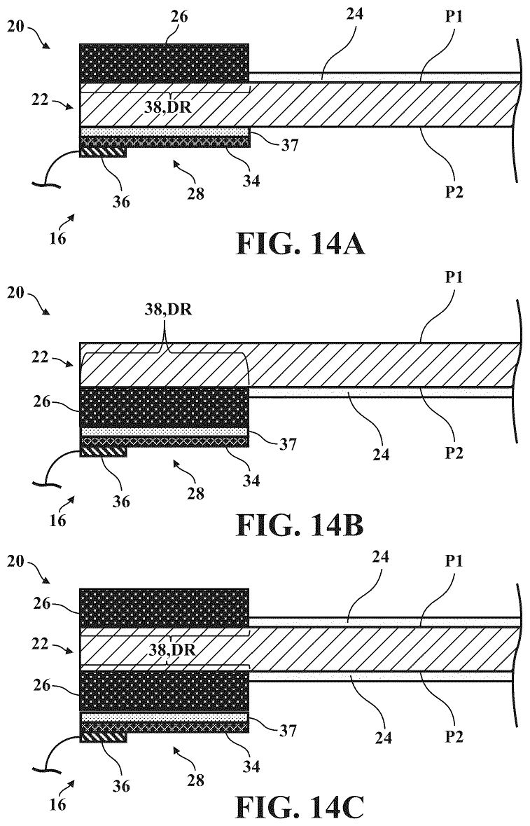

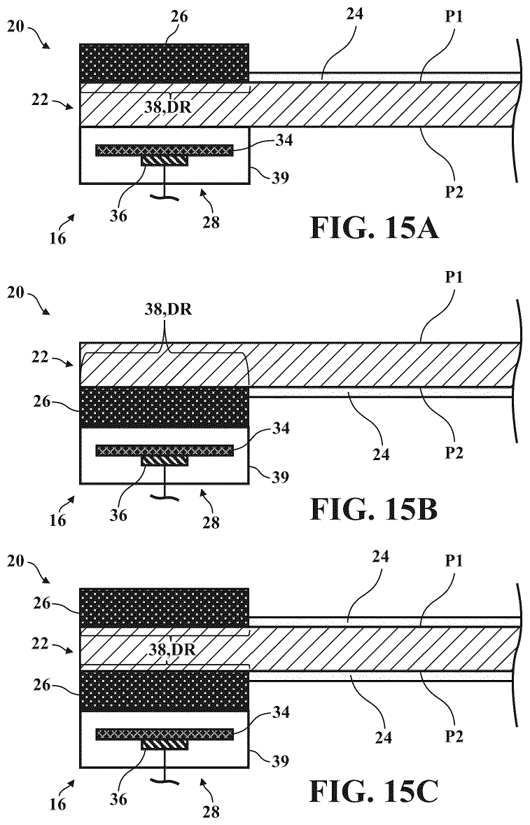

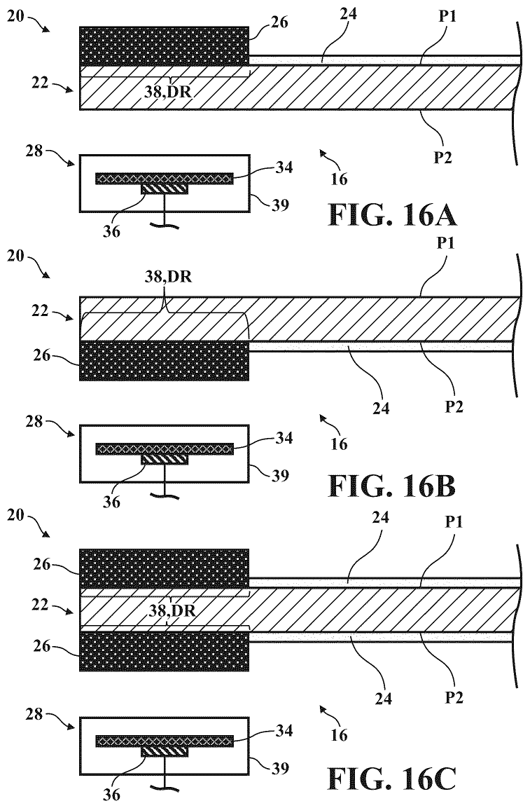

In examples where the antenna assembly 28 is coupled to the glass substrate 22, the radiating portion 34 may be printed or otherwise formed on the glass substrate 22 (see e.g. FIGS. 13A-13C, described in further detail below), the antenna assembly 28 may include a carrier layer 37 coupled to the glass substrate 22 (e.g. via an adhesive) and supporting the radiating portion 34 (see e.g. FIGS. 14A-14C, described in further detail below), or the antenna assembly 28 may be an antenna module including a housing 39 coupled to the glass substrate 22 and enclosing the radiating portion 34 (see e.g. FIGS. 15A-15C, described in further detail below). Other configurations where the antenna assembly 28 is coupled directly to the glass substrate 22 are contemplated. In examples where the antenna assembly 28 is spaced from the glass substrate 22, the antenna assembly 28 may be an antenna module including a housing 39 supported elsewhere in the vehicle 18 or building 19 (see e.g. FIGS. 16A-16C, described in further detail below). Other configurations where the antenna assembly 28 is spaced from the glass substrate 22 are contemplated.

FIGS. 13A-13C illustrate examples of the antenna assembly 28 where the radiating portion 34 is printed or otherwise formed on the glass substrate 22. In one example, the radiating portion 34 of the antenna assembly 28 is formed by virtue of screen-printing a conductive paste (e.g. silver paste) on the glass substrate 22 and subsequently firing the conductive paste (this operation can be performed in conjunction with steps S3 and S4 or as an independent operation). In another example, the radiating portion 34 of the antenna assembly 28 is formed by virtue of digitally printing a conductive ink on the glass substrate 22 (this operation is typically performed after step S4 such that the conductive ink is not subject to excessive heat). Exemplary processes of digitally printing radiating portions 34 of antenna assemblies 28 are described in U.S. Pat. No. 11,773,011, issued on Oct. 3, 2023 and assigned to AGC Automotive Americas Co., the contents of which is herein incorporated by reference in its entirety. Other techniques for printing or otherwise forming the radiating portion 34 on the glass substrate 22 are contemplated. In these examples, the radiating portion 34 and/or the feeding portion is additionally configured to be energized to also heat (e.g. to defrost) the glass substrate 22.

The antenna assembly 28 may be disposed relative to the P2 surface such that the glazing assembly 20 shields the antenna assembly 28 from the environment outside the vehicle 18 or building 19. Accordingly, for each of FIGS. 13A-13C, the radiating portion 34 of the antenna assembly 28 is printed or otherwise formed on the P2 surface of the glass substrate 22. Referring to FIG. 13A, for examples where the enamel 26 is disposed relative to the P1 surface, the radiating portion 34 of the antenna assembly 28 may be printed or otherwise formed directly on the P2 surface and may be arranged at least partially within the perimeter 38 of the decoated region DR to transmit and/or receive radio frequency signals through the decoated region DR, as described above. Referring to FIGS. 13B and 13C, for examples where the enamel 26 is disposed relative to at least the P2 surface, the radiating portion 34 of the antenna assembly 28 may be printed or otherwise formed over the enamel 26 disposed relative to the P2 surface such that the radiating portion 34 is arranged at least partially within the perimeter 38 of the decoated region DR to transmit and/or receive radio frequency signals through the decoated region DR, as described above. In each of FIGS. 13A-13C, the feeding portion 36 of the antenna assembly 28 is illustrated as a direct feeding structure including a coaxial cable coupled to the radiating portion 34 to energize the radiating portion 34 but other feeding arrangements are contemplated. Other configurations of the antenna assembly 28 where the radiating portion 34 is printed or otherwise formed on the glass substrate 22 are contemplated.

FIGS. 14A-14C illustrate examples of the antenna assembly 28 including a carrier layer 37 coupled to the glass substrate 22 and supporting the radiating portion 34. In these examples, the carrier layer 37 may comprise a printed circuit board (PCB) or a polymeric film comprising a suitable material such as polyethylene terephthalate (PET) or the like, and the radiating portion 34 may comprise a metallization layer (e.g. silver, copper, or the like) disposed on a surface of or encapsulated within the carrier layer 37. The carrier layer 37 may be coupled to the glass substrate 22 with an adhesive such as polyurethane, an optically clear adhesive, or the like. In the illustrated examples, the carrier layer 37 is coupled to the P2 surface such that the glazing assembly 20 shields the antenna assembly 28 from the environment outside the vehicle 18 or building 19. Referring to FIG. 14A, for examples where the enamel 26 is disposed relative to the P1 surface, the carrier layer 37 may be coupled directly to the P2 surface such that the radiating portion 34 is arranged at least partially within the perimeter 38 of the decoated region DR to transmit and/or receive radio frequency signals through the decoated region DR, as described above. Referring to FIGS. 14B and 14C, for examples where the enamel 26 is disposed relative to at least the P2 surface, the carrier layer 37 may be coupled to the enamel 26 disposed on the P2 surface such that the radiating portion 34 is arranged at least partially within the perimeter 38 of the decoated region DR to transmit and/or receive radio frequency signals through the decoated region DR, as described above. In each of FIGS. 14A-14C, the feeding portion 36 of the antenna assembly 28 is illustrated as a direct feeding structure including a coaxial cable coupled to the radiating portion 34 to energize the radiating portion 34 but other feeding arrangements are contemplated. Other configurations of the antenna assembly 28 where the radiating portion 34 is supported by a carrier layer 37 are contemplated.

FIGS. 15A-15C illustrate examples of the antenna assembly 28 where the antenna assembly 28 is an antenna module including a housing 39 coupled to the glass substrate 22 and enclosing the radiating portion 34. In these examples, the housing 39 may comprise a suitable material (e.g. plastic) and the radiating portion 34 and/or the feeding portion 36 may be disposed within the housing 39. For example, the housing 39 may enclose a printed circuit board (PCB) which includes the radiating portion 34 and/or the feeding portion 36, but other configurations are contemplated. The housing 39 may be coupled to the glass substrate 22 directly with an adhesive such as polyurethane or the like, or the housing 39 may be indirectly coupled to the glass substrate 22 via a bracket or the like. In the illustrated examples, the housing 39 is coupled to the P2 surface such that the glazing assembly 20 shields the antenna assembly 28 from the environment outside the vehicle 18 or building 19. Referring to FIG. 15A, for examples where the enamel 26 is disposed relative to the P1 surface, the housing 39 may be directly coupled to the P2 surface such that the radiating portion 34 is arranged at least partially within the perimeter 38 of the decoated region DR to transmit and/or receive radio frequency signals through the decoated region DR, as described above. Referring to FIGS. 15B and 15C, for examples where the enamel 26 is disposed relative to at least the P2 surface, the housing 39 may be coupled to the enamel 26 disposed relative to the P2 surface such that the radiating portion 34 is arranged at least partially within the perimeter 38 of the decoated region DR to transmit and/or receive radio frequency signals through the decoated region DR, as described above. In each of FIGS. 15A-15C, the feeding portion 36 of the antenna assembly 28 is illustrated as a direct feeding structure including a coaxial cable coupled to the radiating portion 34 to energize the radiating portion 34 but other feeding arrangements are contemplated. Other configurations of the antenna assembly 28 where the antenna assembly 28 is an antenna module including a housing 39 coupled to the glass substrate 22 are contemplated.

FIGS. 16A-16C illustrate examples of the antenna assembly 28 where the antenna assembly 28 is an antenna module including a housing 39 supported elsewhere in the vehicle 18 or building 19 and enclosing the radiating portion 34. For the purposes of FIGS. 16A-16C, the antenna assembly 28 is schematically illustrated as spaced from the glass substrate 22. It should be appreciated that in these examples, the housing 39 may be supported at any suitable location within the interior of the vehicle 18 (e.g. within the dashboard, trunk cargo shelf, etc.) or building 19. In any event, the housing 39 may be arranged such that the radiating portion 34 is arranged at least partially within/aligned with the perimeter 38 of the decoated region DR to transmit and/or receive radio frequency signals through the decoated region DR, as described above. For examples where the radiating portion 34 is implemented as a directional radiating portion 34, the housing 39 may be arranged within the vehicle 18 or building 19 such that the directionality of the radiating portion 34 is oriented through the decoated region DR to transmit and/or receive radio frequency signals through the decoated region DR. Other configurations of the antenna assembly 28 where the antenna assembly 28 is an antenna module including a housing 39 supported elsewhere in the vehicle 18 or building 19 are contemplated.

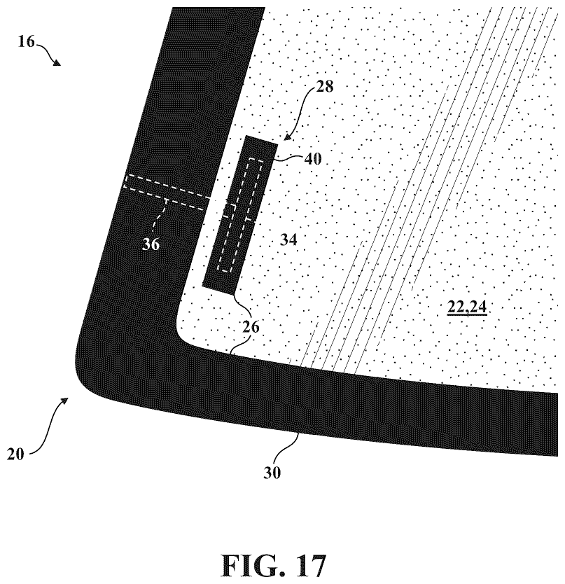

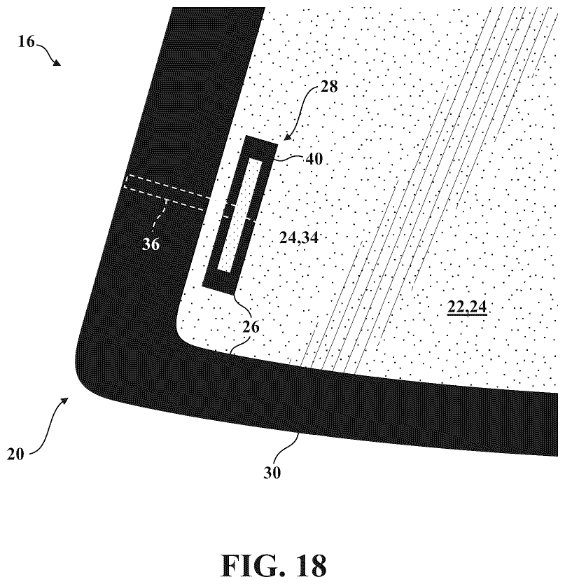

As alluded to above, in some examples, the portion 25 of the conductive coating 24 relative to which the enamel 26 is disposed may additionally or alternatively define standalone regions (i.e., regions spaced from peripheral edge 32 of the glazing assembly 20 and not connected to the band 30) beneath which the antenna assembly 28 may be disposed. Referring to FIGS. 17 and 18, for example, the decoated region DR may define an island 40 that is substantially free of the conductive coating 24, as described above. Here, the island 40 is substantially free of the conductive coating 24 but surrounded by the conductive coating 24 on all sides of its perimeter. In these examples, as shown in FIGS. 17 and 18, the antenna assembly 28 may include a radiating portion 34 disposed on the glass substrate 22 within the island 40 and configured to be energized to transmit and/or receive radio frequency signals through the island 40. As illustrated in FIGS. 17 and 18, a feeding portion 36 of the antenna assembly 28 may be coupled to the radiating portion 34 to energize the radiating portion 34 to transmit and/or receive radio frequency signals through the island 40. In the configuration of FIG. 17, the radiating portion 34 of the antenna assembly 28 (illustrated in phantom) may be printed or otherwise formed on the glass substrate 22, as described above. In another example, such as shown in FIG. 18, the decoated region DR may be defined such that a portion of the conductive coating 24 remains within the island 40 to function as the radiating portion 34 of the antenna assembly 28. Other configurations of the antenna assembly 28 configured to be energized to transmit and/or receive radio frequency signals through a decoated region DR defining an island 40 are contemplated.

In some examples, the decoated region DR may define a specific geometry configured to facilitate electromagnetic cooperation of the conductive coating 24 with the antenna assembly 28 to facilitate the antenna assembly 28 transmitting and/or receiving radio frequency signals. For example, the decoated region DR may shaped such that a portion of the conductive coating 24 is configured to function as a radiating element 34, the decoated region DR may define additional geometries of the conductive coating 24 configured to electromagnetically augment the antenna assembly 28 transmitting and/or receiving radio frequency signals (e.g., signal enhancing structures such as a resonant ring or the like), or the decoated region DR may be patterned to constitute a frequency selective surface. Other configurations where the decoated region DR defines a specific geometry configured to facilitate electromagnetic cooperation of the conductive coating 24 with the antenna assembly 28 to facilitate the antenna assembly 28 transmitting and/or receiving radio frequency signals through the decoated region DR are contemplated. For example, in some configurations, the decoated region DR may be defined such that the conductive coating 24 functions as a ground plane which electromagnetically cooperates with the radiating portion 34 to transmit and/or receive radio frequency signals through the decoated region DR.

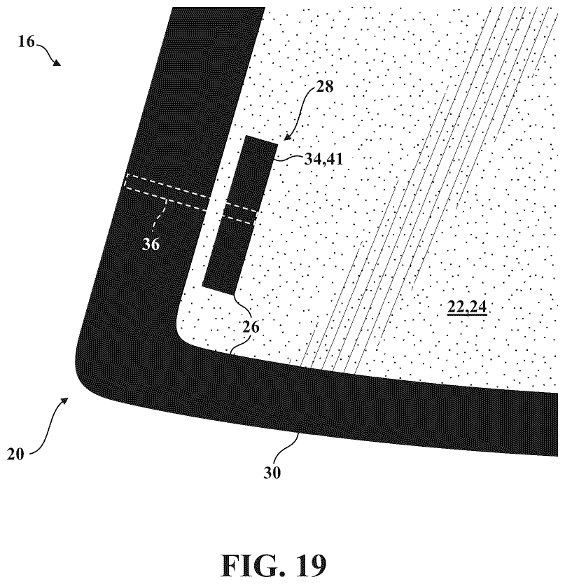

In one example, referring to FIG. 19, the decoated region DR may define a slot 41 that is substantially free of the conductive coating 24, as described above. In some examples, such as shown in FIG. 19, the slot 41 may be defined by the enamel 26 being disposed on a standalone portion 25 of the conductive coating 24 to at least partially dissolve the standalone portion 25 of the conductive coating 24 to establish the slot 41. Here, the slot 41 is substantially free of the conductive coating 24 but surrounded by the conductive coating 24 on all sides. In other examples, the slot 41 may be defined by a peninsula of the enamel 26 connected to and extending from the band 30. In these examples, the slot 41 may function as a radiating portion 34 configured to be energized to transmit and/or receive radio frequency signals. As illustrated in FIG. 19, a feeding portion 36 of the antenna assembly 28 may extend across the slot 41 to energize the slot 41 to transmit and/or receive radio frequency signals. In these examples, the antenna assembly 28 may be particularly suitable for transmitting and/or receiving radio frequency signals using digital broadcasting protocols (e.g. DAB or DTV) but other operational frequencies are contemplated. Other exemplary configurations of decoated regions defining specific geometry configured to facilitate electromagnetic cooperation of conductive coatings with antenna assemblies to facilitate the antenna assembly transmitting and/or receiving radio frequency signals are described in U.S. Pat. No. 9,647,319, issued May 9, 2017 and assigned to AGC Automotive Americas Co.; U.S. Pat. No. 9,755,299, issued Sep. 5, 2017 and assigned to AGC Automotive Americas Co.; U.S. U.S. Pat. No. 9,806,398, issued Oct. 31, 2017 and assigned to AGC Automotive Americas Co.; and U.S. Pat. No. 9,960,482, issued May 1, 2018 and assigned to AGC Automotive Americas Co., the contents of which are herein incorporated by reference in their entirety.

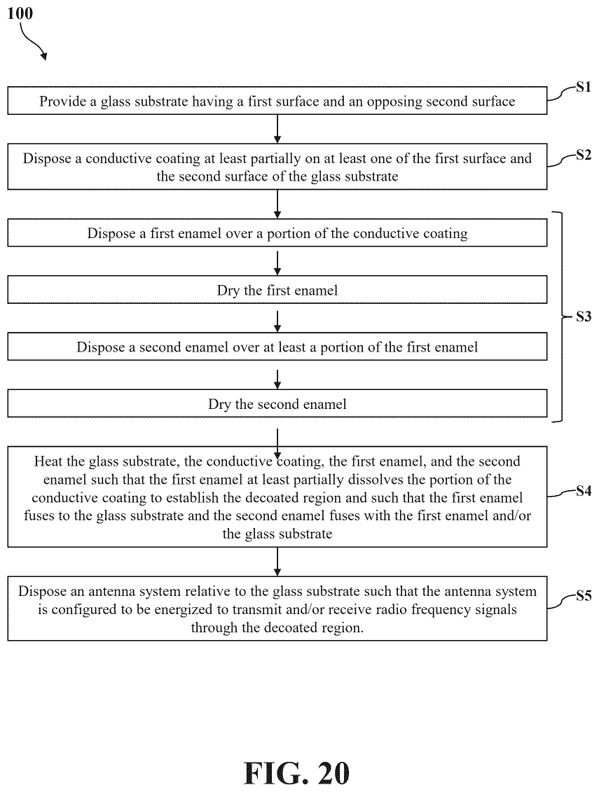

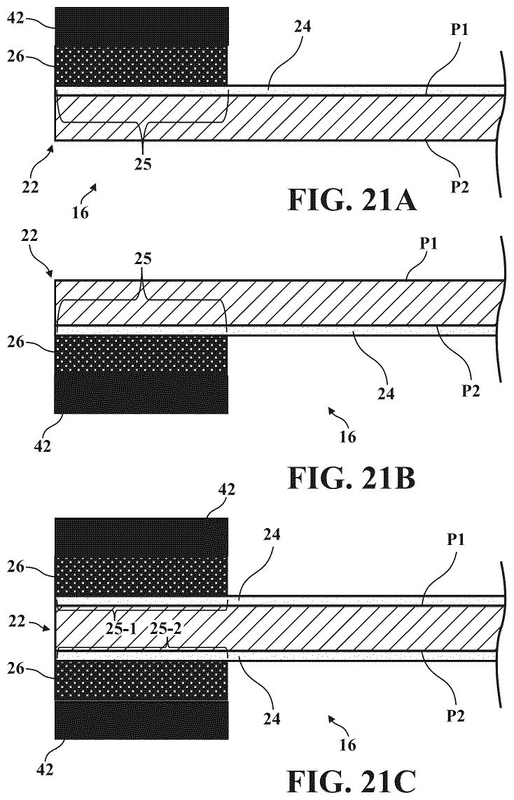

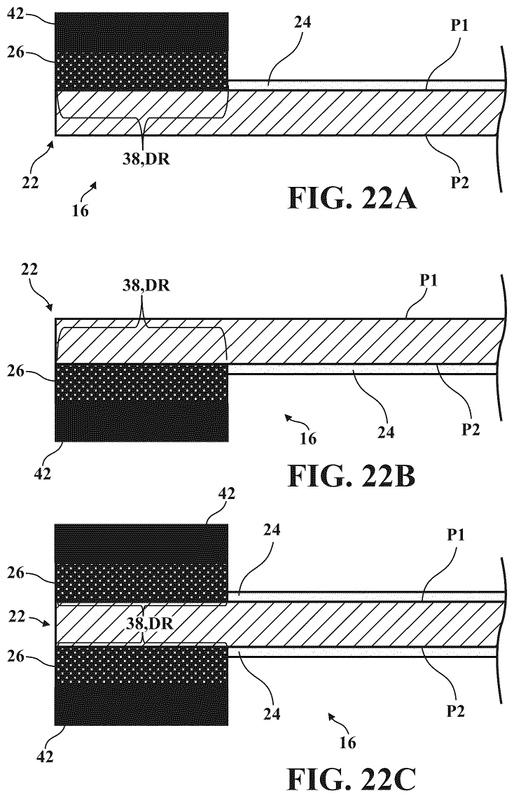

Referring to FIGS. 20-22C, as described above, step S3 of the method 100 includes disposing the enamel 26 relative to a portion 25 of the conductive coating 24. In some examples, the enamel 26 (which is comprised of a composition or includes additives which, when subjected to heat, chemically interact with the adjacent portion 25 of the conductive coating 24 to at least partially dissolve the adjacent portion 25 of the conductive coating 24) is defined as a first enamel 26, and, referring to the flowchart of FIG. 20 and FIGS. 21A-21C, step S3 additionally includes disposing a second enamel 42, different from the first enamel 26, over at least a portion of the first enamel 26. Here, the second enamel 42 is typically a conventional black ceramic enamel 42. In these examples, disposing the second enamel 42 over at least a portion of the first enamel 26 may function to protect the underlying first enamel 26 and/or to improve the adhesion of the glazing assembly 20 to the vehicle 18 or building 19. In these examples, as shown in the flowchart of FIG. 20, step S3 typically includes disposing the first enamel 26 over the portion 25 of the conductive coating 24, drying the first enamel 26 (e.g. heating the first enamel 26 to a temperature from 100° C. to 150° C.), disposing the second enamel 42 over at least a portion of the first enamel 26, and drying the second enamel 42 (e.g. heating the first enamel 26 to a temperature from 100° C. to 150° C.) . . . . In these examples, as shown in FIGS. 22A-22C, step S4 includes heating the glass substrate 22, the conductive coating 24, the first enamel 26, and the second enamel 42 such that the first enamel 26 at least partially dissolves the portion 25 of the conductive coating 24 to establish the decoated region DR (as described above) and such that the first enamel 26 fuses to the glass substrate 22 and the second enamel 42 fuses with the first enamel 26 and/or the glass substrate 22.

In some examples, the glazing assembly 20 may be formed as a laminated glazing assembly 120 including multiple glass substrates and one or more polymeric interlayers disposed therebetween. FIG. 23 is one example of a system 16 according to the present disclosure including a laminate glazing assembly 120. In the illustrated example, the laminated glazing assembly 120 is a windshield of a vehicle 18, but it should also be appreciated that laminated glazing assemblies 120 according to the present disclosure may also be employed in the automotive context as rear windows, side windows, quarter windows, roof glass panels, and the like, or even in a building context. As described in further detail below, the laminated glazing assembly 120 generally includes a first glass substrate 122A (analogous to the glass substrate 22, described in detail above) having an outer surface (P1) and an opposing inner surface (P2), a second glass substrate 122B having a third surface (P3) and an opposing fourth surface (P4), and a polymeric interlayer 144 disposed between the P2 surface and the P3 surface (described in further detail below). In these examples, the P4 surface is typically arranged to face the interior of the vehicle 18 or building 19 where the laminated glazing assembly 120 is installed in the vehicle 18 or building 19, and the P1 surface is arranged to face outward from the vehicle 18 or building 19 where the laminated glazing assembly 120 is installed in the vehicle 18 or building 19. The laminated glazing assembly 120 also generally includes a conductive coating 124 at least partially disposed on at least one of the P1 surface, the P2 surface, the P3 surface, and the P4 surface. The conductive coating 124 inhibits transmission of radio frequency signals therethrough. The laminated glazing assembly 120 further includes an enamel 126 at least partially disposed relative to a portion 125 of the conductive coating 124 to at least partially dissolve the portion 125 of the conductive coating 124 to define a decoated region DR on the at least one of the P1 surface, the P2 surface, the P3 surface, and the P4 surface to permit transmission of radio frequency signals therethrough. The laminated glazing assembly 120 additionally includes an antenna assembly 128 arranged relative to one of the first glass substrate 122A and the second glass substrate 122B such that the antenna assembly 128 is configured to be energized to transmit and/or receive radio frequency signals through the decoated region DR.

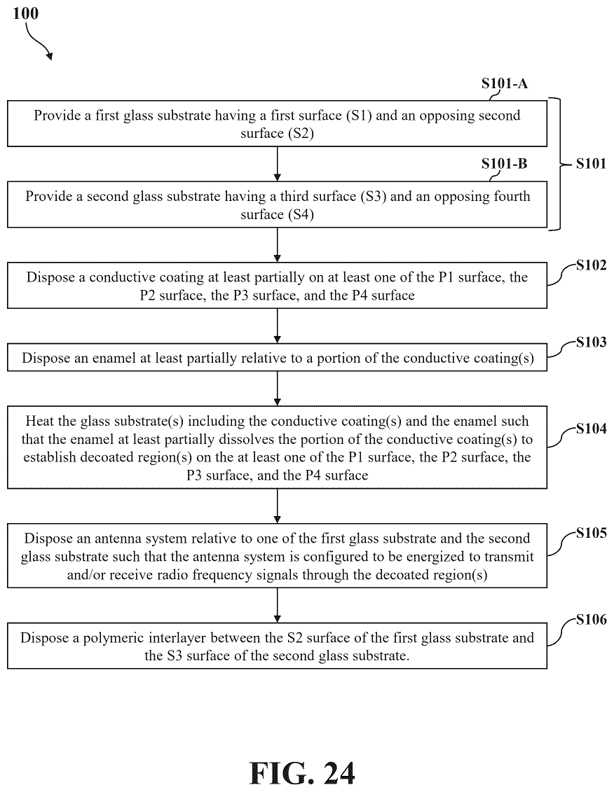

FIG. 24 is a flowchart illustrating a variation of the method 100 according to the present disclosure where the glazing assembly 20 is a laminated glazing assembly 120. Referring to FIG. 24, in these examples, the method 100 generally includes a first step S101 (similar to step S1, described above) including a first sub-step 101-A of providing a first glass substrate 122A having a first surface (P1) and an opposing second surface (P2), and a second sub-step 101-B of providing a second glass substrate 122B having a third surface (P3) and an opposing fourth surface (P4).

The first glass substrate 122A and second glass substrate 122B may be similar to the glass substrate 22 described above. The first glass substrate 122A has a thickness T1 (similar to the glass substrate 22, described above), and the second glass substrate 122B has a thickness T2. The thickness T2 of the second glass substrate 122B may be any suitable thickness for the application. For example, in vehicle applications, the thickness T2 may be from about 0.3 mm to about 5.0 mm. More specifically, the thickness T2 may be about 0.3 mm, 0.4 mm, 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm. 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm, 3.0 mm, 3.1 mm, 3.2 mm, 3.3 mm, 3.4 mm, 3.5 mm, 3.6 mm, 3.7 mm, 3.8 mm, 3.9 mm, 4.0 mm, 4.1 mm, 4.2 mm, 4.3 mm, 4.4 mm, 4.5 mm, 4.6 mm, 4.7 mm, 4.8 mm, 4.9 mm, or 5.0 mm. For non-vehicle applications (e.g. building applications), the thickness T2 it typically from 3.0 mm to 12.0 mm but other values for the thickness T2 are contemplated.

It should be appreciated that the thickness T1 of the first glass substrate 122A and the thickness T2 of the second glass substrate 122B can be the same or different. In one example, the first glass substrate 122A and the second glass substrate 122B have the same thickness (i.e., where T1 is equal to T2) such that the laminated glazing assembly 120 is considered a “symmetric” laminate. However, in other examples, the first glass substrate 122A and the second glass substrate 122B have different thicknesses (i.e., where T1 is not equal to T2) such that the laminated glazing assembly 120 is considered an “asymmetric” laminate. All combinations of the exemplary T1 and T2 values listed above and all fractional values therebetween are contemplated. In some examples, the first glass substrate 122A and the second glass substrate 122B have the same composition. In other examples, the first glass substrate 122A and the second glass substrate 122B have different compositions.

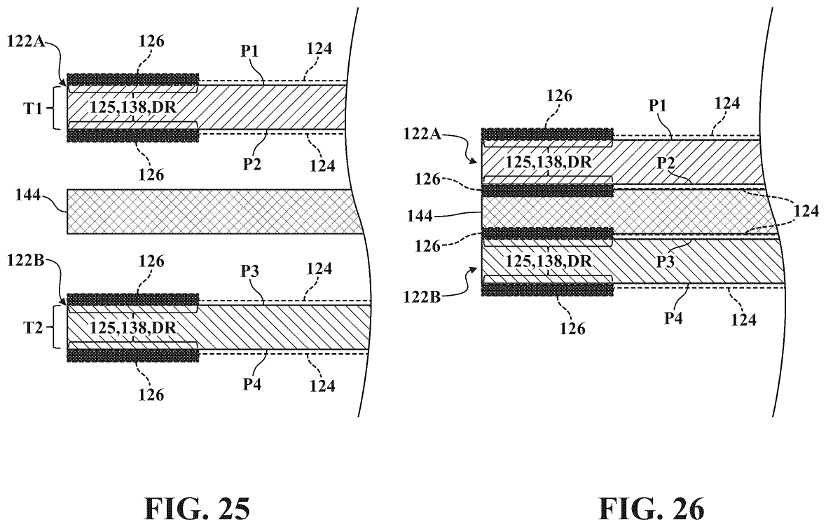

With continued reference to FIG. 24, the method 100 also includes a second step S102 (similar to step S2, described above) of at least partially disposing a conductive coating 124 on at least one of the P1 surface, the P2 surface, the P3 surface, and the P4 surface. Stated differently, a conductive coating 124 may be at least partially disposed on only the P1 surface, on only the P2 surface, on only the P3 surface, on only the P4 surface, or on any combination of the P1 surface, the P2 surface, the P3 surface, and the P4 surface. FIGS. 25 and 26 illustrate the potential locations of the conductive coating 124 in phantom relative to the first glass substrate 122A and the second glass substrate 122B. The conductive coating 124 may be at least partially disposed on the on at least one of the P1 surface, the P2 surface, the P3 surface, and the P4 surface according to any of the exemplary processes described above in the context of step S2 and may comprise any of the exemplary compositions described above in the context of step S2. In some examples, the conductive coating 124 may be omitted from the surface of the glass substrate which faces the exterior of the vehicle 18 or building 19 (e.g. the P1 surface), particularly where the composition of the conductive coating 124 is not sufficiently durable to withstand being exposed to the environment outside of the vehicle 18 or building 19.

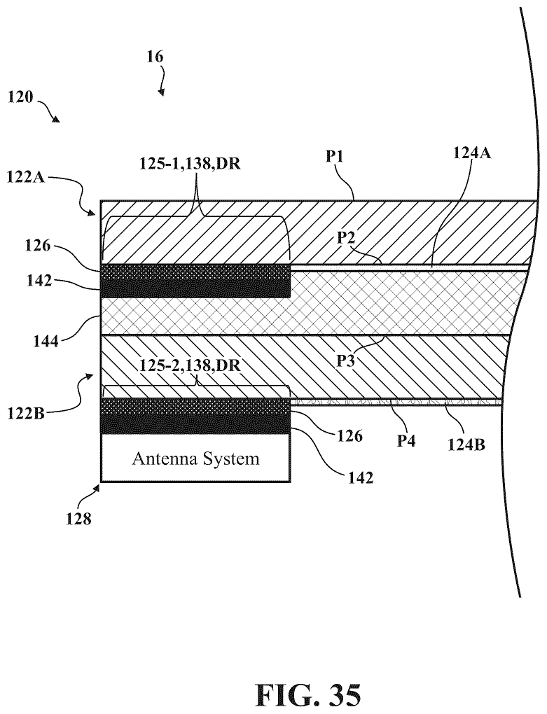

The conductive coating 124 may be at least partially disposed on more than one of the P1 surface, the P2 surface, the P3 surface, and the P4 surface. In certain examples where the conductive coating 124 is at least partially disposed on more than one of the P1 surface, the P2 surface, the P3 surface, and the P4 surface, the composition of the conductive coating 124 may be the same on each surface where the conductive coating 124 is disposed. In other examples, conductive coatings 124 having differing compositions may be disposed on each surface. Stated differently, in some examples, the conductive coating 124 may be a first conductive coating 124A having a first composition and at least partially disposed on one of the P1 surface, the P2 surface, the P3 surface, and the P4 surface, and a second conductive coating 124B having a second composition, different from the first composition, may be at least partially disposed on another of the P1 surface, the P2 surface, the P3 surface, and the P4 surface. FIG. 35 (described in further detail below) illustrates one typical example of such a configuration, where the first conductive coating 124A is disposed on the P2 surface and comprises a metal, and the second conductive coating 124B disposed on the P4 surface comprises a transparent conductive oxide. Other configurations are contemplated. As described in further detail below in the context of step S104, where the conductive coating 124 is at least partially disposed on more than one of the P1 surface, the P2 surface, the P3 surface, and the P4 surface, it is sometimes preferable from a heating and/or bending perspective to dispose the conductive coating(s) 124 on surfaces of the glass substrates 122A, 122B that face the same direction (e.g. disposing the conductive coating(s) 124 on a combination of the P1 surface and the P3 surface, or a combination of the P2 surface and the P4 surface).

Referring back to FIG. 24, the method 100 further includes a third step S103 (similar to step S3, described above) of at least partially disposing an enamel 126 relative to a portion 125 of the conductive coating(s) 124. The enamel 126 may be disposed relative to the portion 125 of the conductive coating(s) 124 according to any of the exemplary processes described above in the context of step S3 and may comprise any of the exemplary compositions described above in the context of step S3. Furthermore, similar to as described above in the context of step S2 and step S3, it should be appreciated that the order in which step S102 and step S103 are carried out may be switched in certain examples. FIGS. 25-27 illustrate the potential locations of the enamel 126 in phantom relative to the first glass substrate 122A and the second glass substrate 122B. Similar to as described above in the context of step S3, where the conductive coating 124 is at least partially disposed on only one of the P1 surface, the P2 surface, the P3 surface, and the P4 surface, the enamel 126 is at least partially disposed relative to the portion 125 of the conductive coating 124 to at least partially dissolve the adjacent portion 125 of the conductive coating 124 to define a decoated region DR when subjected to step S104.

For examples where a conductive coating 124 is disposed on more than one of the P1 surface, the P2 surface, the P3 surface, and the P4 surface, the enamel 126 may be disposed relative to a respective portion 125 of each conductive coating 124 to at least partially dissolve the respective portion 125 of each the conductive coating 124 to define a respective decoated region DR when subjected to step S104. Typically, as illustrated by the potential locations of the enamel 126 in phantom in FIGS. 25-27, each layer of enamel 126 at least partially overlaps the other layers of enamel 126 such that the decoated regions DR of each conductive coating 124 at least partially overlap such that the antenna assembly 28 may transmit and/or receive radio frequency signals through each of the decoated regions DR. As best shown in FIG. 35, in some examples, a first conductive coating 124A is at least partially disposed on one of the P1 surface, the P2 surface, the P3 surface, and the P4 surface and a second conductive coating 124B is at least partially disposed on another of the P1 surface, the P2 surface, the P3 surface, and the P4 surface, the enamel 26 is disposed relative to a first portion 125-1 of the first conductive coating 124A and relative to a second portion 125-2 of the second conductive coating 124B to at least partially dissolve the first portion 125-1 of the first conductive coating 124A to define a first decoated region DR-1 and to at least partially dissolve the second portion 125-2 of the second conductive coating 124B to define a second decoated region DR-2. Here, the first decoated region DR-1 and the second decoated region DR-2 at least partially overlap such that the antenna assembly 128 may transmit and/or receive radio frequency signals through the first decoated region DR-1 and the second decoated region DR-2.

Similar to as described above in the context of step S3, as best shown in FIG. 23, in some examples, the portion 125 of the conductive coating 124 relative to which the enamel 126 is disposed is defined such that the enamel 126 is formed as a band 130 extending around a peripheral edge 132 of the laminated glazing assembly 120. In these examples, the band 130 blocks transmission of light through the region of the laminated glazing assembly 120 extending around the peripheral edge 132. In doing so, the band 130 prevents UV light from deteriorating an underlying adhesive that may bond the laminated glazing assembly 120 to the vehicle 18 or building 19, and blocks visibility of the underlying adhesive to an outside observer, providing an improved aesthetic exterior appearance. Here, the antenna assembly 128 may be disposed beneath the band 130 such that the antenna assembly 128 may transmit and/or receive radio frequency signals through the decoated region DR defined by the band 130.

In some examples, similar to as described above in the context of FIGS. 20-22C, the enamel 126 is defined as a first enamel 126, and step S103 may additionally include disposing a second enamel 142, different from the first enamel 126, over at least a portion of the first enamel 126. Here, the second enamel 142 is typically a conventional black ceramic enamel 142. Accordingly, disposing the second enamel 142 over at least a portion of the first enamel 126 may function to protect the underlying first enamel 126 and/or to improve the adhesion of the laminated glazing assembly 120 to the vehicle 18 or building 19 or adhesion of the glass substrates 122A, 122B to the polymeric interlayer 144 (described in further detail below). In these examples, step S103 typically includes disposing the first enamel 126 over the portion 125 of the conductive coating 124, drying the first enamel 126 (e.g. heating the first enamel 126 to a temperature from 100° C. to 150° C.), disposing the second enamel 142 over at least a portion of the first enamel 126, and drying the second enamel 142 (e.g. heating the first enamel 126 to a temperature from 100° C. to 150° C.).

Referring back to FIG. 24, the method 100 additionally includes a fourth step S104 (similar to step S4, described above) of heating the glass substrate(s) 122A, 122B which include the conductive coating(s) 124 and the enamel 126 disposed thereon such that the enamel 126 at least partially dissolves the adjacent portion(s) 125 of the conductive coating(s) 124 to establish decoated region(s) DR on the at least one of the P1 surface, the P2 surface, the P3 surface, and the P4 surface such that the decoated region(s) DR permit transmission of radio frequency signals therethrough. Generally, step S104 may be carried out according to any of the exemplary processes described above in the context of step S4.

In the case of laminated glazing assemblies 120, step S104 only needs to be performed on the glass substrate(s) 122A, 122B over which the conductive coating(s) 124 and the enamel 126 is/are disposed. Stated differently, in examples of a laminated glazing assembly 120 where the conductive coating 124 and enamel 126 are disposed on only the P1 surface and/or the P2 surface of the first glass substrate 122A (e.g. where the second glass substrate 122B is uncoated), the fourth step S104 includes heating the first glass substrate 122A, the conductive coating 124 disposed on the first glass substrate 122A, and the enamel 126 disposed relative to the portion 125 of the conductive coating 124 such that the enamel 126 at least partially dissolves the portion 125 of the conductive coating 124 to establish the decoated region(s) DR on the P1 surface and/or the P2 surface such that the decoated region(s) DR permit transmission of radio frequency signals therethrough. In these examples, because the second glass substrate 122B does not have the conductive coating 124 and/or the enamel 126, the second glass substrate 122B does not have to be subjected to step S104. Similarly, in examples of a laminated glazing assembly 120 where the conductive coating 124 is disposed on only the P3 surface and/or the P4 surface of the second glass substrate 122B (e.g. where the first glass substrate 122A is uncoated), the fourth step S104 includes heating the second glass substrate 122B, the conductive coating 124 disposed on the second glass substrate 122B, and the enamel 126 disposed relative to the portion 125 of the conductive coating 124 such that the enamel 126 at least partially dissolves the portion 125 of the conductive coating 124 to establish the decoated region(s) DR on the P3 surface and/or the P4 surface such that the decoated region(s) DR permit transmission of radio frequency signals therethrough. In these examples, because the first glass substrate 122A does not have the conductive coating 124 and/or the enamel 126, the first glass substrate 122A does not have to be subjected to the fourth step S104. Of course, in the examples described above, the glass substrate 122A, 122B that does not include the conductive coating 124 and/or the enamel 126 may be subjected to other heating operations (e.g. to bend the glass substrate 122A,122B).

In examples where both the first glass substrate 122A and the second glass substrate 122B include the conductive coating(s) 124 and the enamel 126 disposed on at least one surface thereof, step S104 includes heating both the first glass substrate 122A and the second glass substrate 122B, as well as the conductive coating 124 and the enamel 126 disposed on each of the first glass substrate 122A and the second glass substrate 122B such that the enamel 126 at least partially dissolves the portion(s) 125 of the conductive coating(s) 124 to establish decoated region(s) DR on the at least one of the P1 surface, the P2 surface, the P3 surface, and the P4 surface such that the decoated region(s) DR permit transmission of radio frequency signals therethrough. In some examples, the first glass substrate 122A and the second glass substrate 122B (each respectively including the conductive coating 124 and the enamel 126 disposed on a surface thereof) may be subjected to step S104 together (e.g. heated while stacked on top of each other), but in other examples, the first glass substrate 122A and the second glass substrate 122B may be subjected to step S104 independently. Furthermore, in some examples, the first glass substrate 122A and the second glass substrate 122B may be subjected to different temperatures during step S104. For example, where the first glass substrate 122A includes a first conductive coating 124A having a first coating composition disposed thereon, and the second glass substrate 122B has a second conductive coating 124B having a second coating composition (different from the first coating composition) disposed thereon, the first glass substrate 122A and the second glass substrate 122B may be subjected to different temperatures during step S104 based on the difference in the coating compositions.

In one example of subjecting the first glass substrate 122A and the second glass substrate 122B to step S104 independently, step S104 includes subjecting the first glass substrate 122A and the second glass substrate 122B to an independent (i.e., sheet-by-sheet) bending process where the first glass substrate 122A and the second glass substrate 122B are each independently heated as described above in the context of step S4 to both i) bend the glass substrates 122A,122B, and ii) such that the enamel 126 at least partially dissolves the adjacent portion(s) 125 of the conductive coating(s) 124 to establish the decoated region(s) DR. In these examples, the bending is typically effectuated via press bending or the like. For instances where the first glass substrate 122A and the second glass substrate 122B are subjected to a press bending process during step S104, the first glass substrate 122A and the second glass substrate 122B typically move along rollers to move the first glass substrate 122A and the second glass substrate 122B into and out of the press bending mold. As alluded to above, glass substrates 122A,122B having conductive coating(s) 124 disposed on both surfaces thereof (e.g. both the P1 surface and P2 surface or both the P3 surface and P4 surface) may be prone to having the conductive coating(s) 124 scratched by these rollers. Therefore, in these examples, it is preferable to dispose the conductive coating(s) 124 on only the surfaces of the glass substrates 122A, 122B that do not face the rollers during the press bending process. For example, in some press bending operations, the P1 surface of the first glass substrate 122A and the P3 surface of the second glass substrate 122B will contact the rollers. In these examples, it is preferable to dispose the conductive coating(s) 124 on the P2 surface and/or the P4 surface. Other configurations and other techniques for heating the glass substrate(s) 122A, 122B which include the conductive coating(s) 124 and the enamel 126 disposed relative thereto such that the enamel 126 at least partially dissolves the portion(s) 125 of the conductive coating(s) 124 to establish decoated region(s) DR on the at least one of the P1 surface, the P2 surface, the P3 surface, and the P4 are contemplated.

Referring back to the flowchart of FIG. 24, the method 100 additionally include a fifth step S105 of disposing an antenna assembly 128 relative to the laminated glazing assembly 120 (e.g. relative to one of the first glass substrate 122A and the second glass substrate 122B) such that the antenna assembly 128 is configured to be energized to transmit and/or receive radio frequency signals through the decoated region(s) DR. As used herein, the phrases “disposed relative to the laminated glazing assembly 120” or “disposed relative to one of the first glass substrate 122A and the second glass substrate 122B” encompasses configurations where the antenna assembly 128 is coupled to the first glass substrate 122A, the antenna assembly 128 is coupled to the second glass substrate 122B, the antenna assembly 128 is disposed between the first glass substrate 122A and the second glass substrate 122B, or the antenna assembly 128 is spaced from the first glass substrate 122A and the second glass substrate 122B (e.g. supported elsewhere in the vehicle 18 or building 19).

Similar to as described above in the context of step S5, the implementation of the antenna assembly 128 is not necessarily limited for the purposes of this disclosure and may generally include any system configured to transmit and/or receive radiofrequency signals. In some configurations, the antenna assembly 128 may be a standalone assembly configured to be coupled to another device (e.g. a modem or the like) which energizes/operates the antenna assembly 128. In other configurations, the antenna assembly 128 may be incorporated within a device (e.g. a cell phone, tablet, computer, etc.). Other configurations of the antenna assembly 128 are contemplated.

The antenna assembly 128 may generally include a radiating portion 134 and a feeding portion 136 coupled to the radiating portion 134 to energize the radiating portion 134 to transmit and/or receive radio frequency signals through the decoated region(s) DR. Here, the radiating portion 134 may be configured as an omnidirectional radiating portion 134 or a directional radiating portion 134. In many configurations, it may be desirable to implement the radiating portion 134 as a directional radiating portion 134 with the directionality of the radiating portion 134 oriented through the decoated region(s) DR. The configuration of the radiating portion 134 is not necessarily limited for the purposes of this disclosure and may include the radiating elements having a monopole configuration, dipole configuration, loop configuration, patch configuration, horn configuration, slot configuration, fractal configuration, the like, and combinations thereof. In some examples, the radiating portion 134 may include a single radiating element or an array of radiating elements. Where the radiating portion 134 includes an array of radiating elements, the array of radiating elements may be a passive array or an active/steerable array. The configuration of the feeding portion 136 is likewise not necessarily limited for the purposes of this disclosure and may include direct feeding configurations (e.g. coaxial or microstrip feeding configurations), indirect feeding configurations (e.g. capacitive feeding configurations), the like, or combinations thereof. For examples where the radiation portion 134 includes an array of radiating elements, the feeding portion may include a feeding network (e.g. series-fed, parallel-fed, or a hybrid thereof), and/or may include active elements for steering the array of radiating elements. Other configurations of the radiating portion 34 and feeding portion 36 are contemplated. It should also be appreciated that the antenna assembly 28 may include additional components (e.g. ground planes, impedance matching structures, etc.).

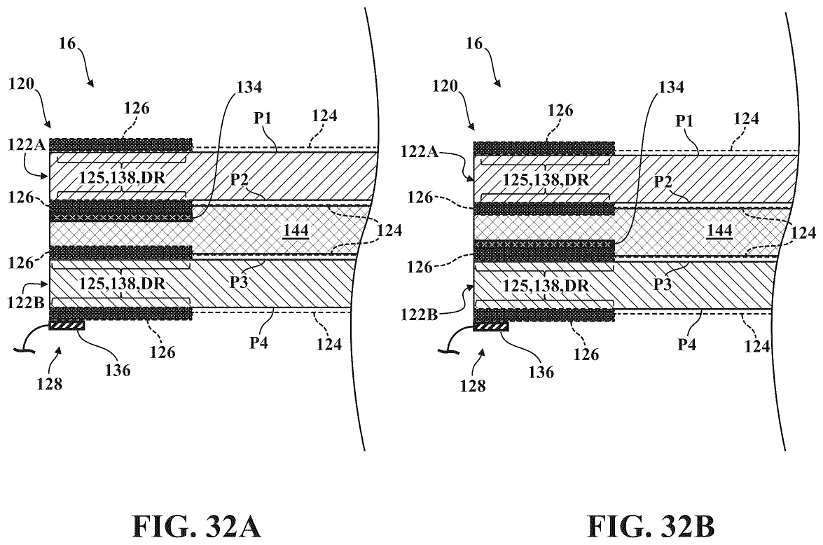

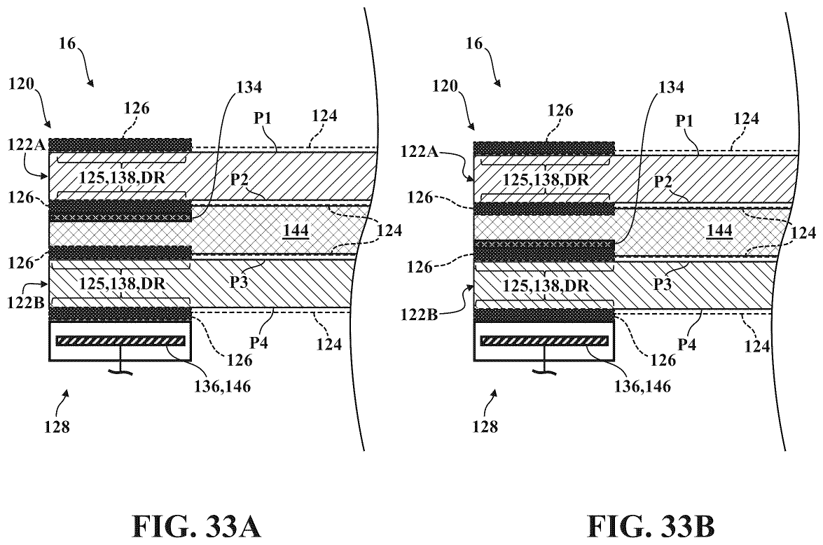

In the context of laminated glazing assemblies 120, it should be appreciated that the antenna assembly 128 may be specifically configured for disposal relative to/within laminated glass assemblies 120. For example, in some configurations, one or more components of the antenna assembly 128 (e.g. the radiating portion 134) may be disposed between the first glass substrate 122A and the second glass substrate 122B. For example, the radiating portion 134 may be disposed on the P2 surface, disposed on the P3 surface, or disposed on a surface of the polymeric interlayer 144. Exemplary configurations of antenna assemblies 128 with one or more components disposed between the first glass substrate 122A and the second glass substrate 122B are described in further detail below in the context of FIGS. 32A-33B.

The antenna assembly 128 may be configured to transmit and/or receive radio frequency signals having linear polarization (e.g. vertical polarization and/or horizontal polarization) and/or circular polarization through the decoated region(s) DR. The antenna assembly 128 is configured to transmit and/or receive radio signals within the frequencies/via the protocols described above in the context of the antenna assembly 28. It should be appreciated that the operating frequency of the antenna assembly 128 is not necessarily limited for the purposes of this disclosure.

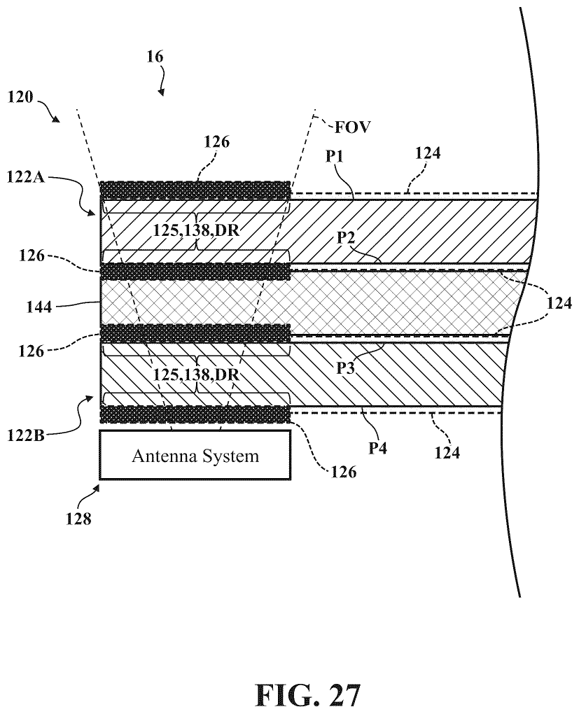

Similar to as described above in the context of step S5, in the context of laminated glazing assembles 120, the decoated region(s) DR may define a perimeter 138 (best shown in FIG. 17), and the antenna assembly 128 may be disposed relative to one of the first glass substrate 122A and the second glass substrate 122B such that at least a portion of the antenna assembly 128 (e.g. the radiating portion 134) is arranged within the perimeter 138 of the decoated region(s) DR to transmit and/or receive radio frequency signals through the decoated region DR. FIG. 27 schematically illustrates the antenna assembly 128 is disposed relative to the P4 surface of the second glass substrate 122B, which faces the interior of the vehicle 18 or building 19, such that the antenna assembly 128 transmits and/or receives radio frequency signals through the decoated region(s) DR and is shielded from the exterior of the vehicle 18 or building 19 by the second glass substrate 122B. As best shown schematically in FIG. 27, especially in examples where the antenna assembly 128 includes a directional radiating portion 134, the antenna assembly 128 may have a field of view FOV, and the perimeter 138 of the decoated region(s) DR may be defined such that the conductive coating(s) 124 do not obstruct the field of view FOV of the antenna assembly 128.

The field of view FOV of the antenna assembly 128 may be static, or the field of view FOV of the antenna assembly 128 may be adjustable (e.g. where the antenna assembly 128 includes an active/steerable radiating portion 134). In examples where the field of view FOV of the antenna assembly 128 is adjustable, the perimeter 138 of the decoated region(s) DR may be defined such that the conductive coating(s) 124 do not obstruct the field of view FOV of the antenna assembly 128 at any point within its adjustability. In examples where the antenna assembly 128 is disposed relative to the P4 surface (such as shown in FIG. 27) and the decoated region(s) DR are established on more than one of the P1 surface, the P2 surface, the P3 surface, and the P4 surface, the perimeter 138 of the decoated region DR on one surface may be different than the perimeter 138 of the decoated region DR on another surface to ensure that each of the conductive coatings 124 do not obstruct the field of view FOV of the antenna assembly 128.

With continued reference to the flowchart of FIG. 24, the method 100 additionally includes a sixth step S106 of disposing a polymeric interlayer 144 between the P2 surface of the first glass substrate 122A and the P3 surface of the second glass substrate 122B. As best shown in FIG. 26, the polymeric interlayer 144 bonds the first glass substrate 122A and the second glass substrate 122B such that the polymeric interlayer 144 retains the first glass substrate 122A and/or the second glass substrate 122B in the event of impact or breakage of the laminated glazing assembly 120. The polymeric interlayer 144 typically includes a polymer or thermoplastic resin, such as polyvinyl butyral (PVB), ethylene-vinyl acetate (EVA), thermoplastic polyurethane (TPU), and the like. Other suitable materials for implementing the polymeric interlayer 144 may be utilized that provide the requisite performance characteristics regarding optical haze, adhesion to glass, and structural rigidity. In some examples, the polymeric interlayer 144 may be substantially transparent or otherwise transparent to light such that the laminated glazing assembly 120 is also substantially transparent or otherwise transparent to light. In other examples, the polymeric interlayer 144 may be tinted or include other additives with at least partially block transmission of light therethrough.

An example lamination process of disposing the polymeric interlayer 144 between the P2 surface of the first glass substrate 122A and the P3 surface of the second glass substrate 122B includes the steps of stacking and aligning the first glass substrate 122A, the second glass substrate 122B, the polymeric interlayer 144, and any other interlayers that may be a part of the laminated glazing assembly 120. After stacking and aligning these components, the stack may be subject to a de-airing process where the stack is subject to a vacuum to remove any air that may be trapped between the first glass substrate 122A, the second glass substrate 122B, the polymeric interlayer 144, and any other interlayers. After the de-airing process, the stack may be subject to an autoclave process where the stack is subject to an elevated temperature and/or an elevated pressure to bond the polymeric interlayer 144 to each of the layers adjacent to the polymeric interlayer 144 to form the laminated glazing assembly 120.

Similar to as described above in the context of FIGS. 17 to 19, in context of laminated glazing assemblies 120, the decoated region(s) DR may define a specific geometry configured to facilitate electromagnetic cooperation of the conductive coating(s) 124 with the antenna assembly 128 to facilitate the antenna assembly 128 transmitting and/or receiving radio frequency signals. For example, the decoated region DR may shaped such that a portion of the conductive coating 124 is configured to function as a radiating element 134, the decoated region DR may define additional geometries of the conductive coating 124 configured to electromagnetically augment the antenna assembly 128 transmitting and/or receiving radio frequency signals (e.g., signal enhancing structures such as a resonant ring or the like), or the decoated region DR may be patterned to constitute a frequency selective surface. Other configurations where the decoated region DR defines a specific geometry configured to facilitate electromagnetic cooperation of the conductive coating 124 with the antenna assembly 128 to facilitate the antenna assembly 128 transmitting and/or receiving radio frequency signals through the decoated region DR are contemplated. For example, in some configurations, the decoated region DR may be defined such that the conductive coating 124 functions as a ground plane which electromagnetically cooperates with the radiating portion 134 to transmit and/or receive radio frequency signals through the decoated region DR.

In one example, the decoated region DR may define an island (similar to as described above in the context of FIGS. 17 and 18) that is substantially free of the conductive coating 24. In these examples, the antenna assembly 128 may include a radiating portion 134 disposed on one of the first glass substrate 122A and the second glass substrate 122B and within the island and configured to be energized to transmit and/or receive radio frequency signals through the island. Similar to as illustrated in FIGS. 17 and 18, a feeding portion 136 of the antenna assembly 128 may be coupled to the radiating portion 134 to energize the radiating portion 134 to transmit and/or receive radio frequency signals through the island. The radiating portion 34 of the antenna assembly 128 may be printed or otherwise formed on one of the first glass substrate 122A and the second glass substrate 122B, as described above. In another example, the decoated region DR may be defined such that a portion of the conductive coating 124 remains within the island to function as the radiating portion 134 of the antenna assembly 128. Other configurations of the antenna assembly 128 configured to be energized to transmit and/or receive radio frequency signals through a decoated region DR defining an island are contemplated. In another example, the decoated region(s) DR may define a slot that is substantially free of the conductive coating(s) 124, or the conductive coating 124 may be configured to electromagnetically cooperate with the radiating portion 134 to function as a ground plane, similar to as described above. Other configurations where the decoated region(s) DR defines a specific geometry configured to facilitate electromagnetic cooperation of the conductive coating(s) 124 with the antenna assembly 128 to facilitate the antenna assembly 128 transmitting and/or receiving radio frequency signals through the decoated region(s) DR are contemplated.

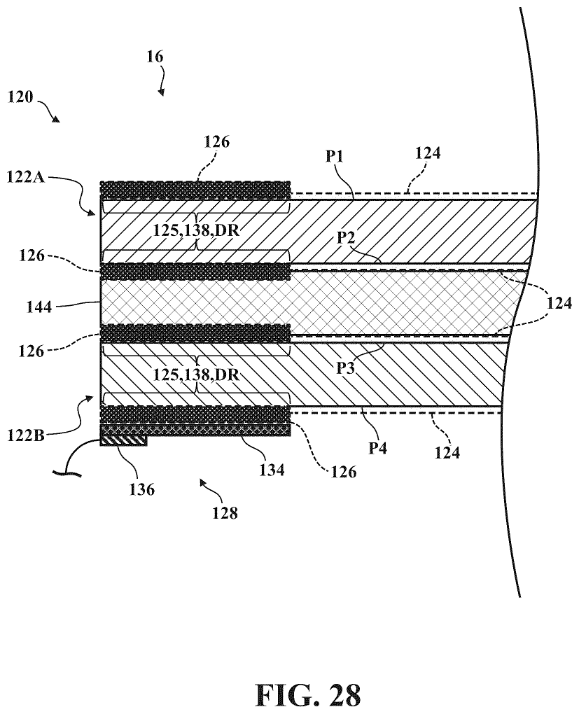

Schematic cross-sectional representations of laminated glazing assemblies 120 according to the present disclosure taken along line B-B of FIG. 23 and including a variety of exemplary configurations of the antenna assembly 128 are shown in FIGS. 28-33B. In each of the examples of FIGS. 28-33B, the laminated glazing assembly 120 includes the first glass substrate 122A having the P1 surface and the P2 surface, the second glass substrate 122B having the P3 surface and the P4 surface, the conductive coating(s) 124 at least partially disposed on at least one of the P1 surface the P2 surface, the P3 surface, and the P4 surface which inhibit transmission of radio frequency signals therethrough, the enamel 126 at least partially disposed relative to a portion 125 of the conductive coating(s) 124 to at least partially dissolve the portion 125 of the conductive coating(s) 124 to establish decoated region(s) DR to permit transmission of radio frequency signals therethrough, and the antenna assembly 128 arranged relative to the laminated glazing assembly 120 such that the antenna assembly 128 is configured to be energized to transmit and/or receive radio frequency signals through the decoated region(s) DR.

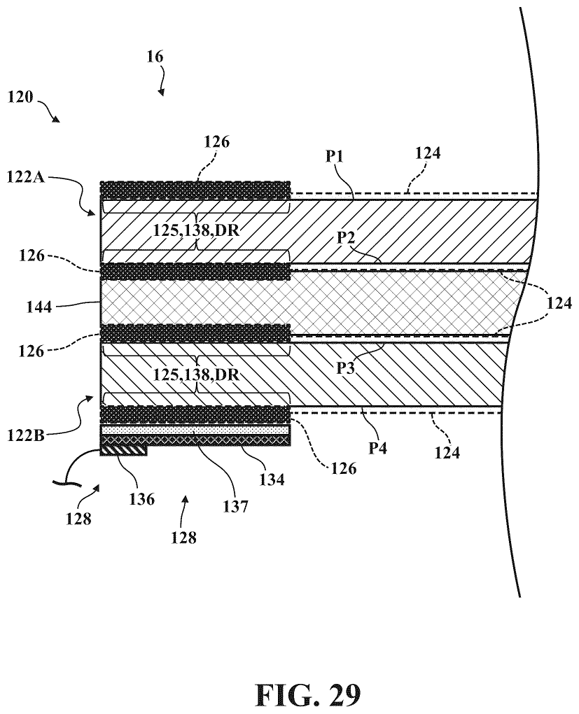

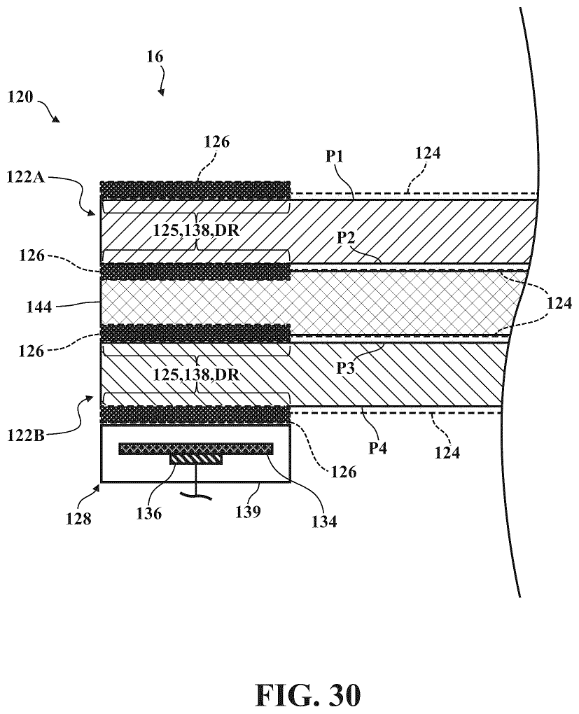

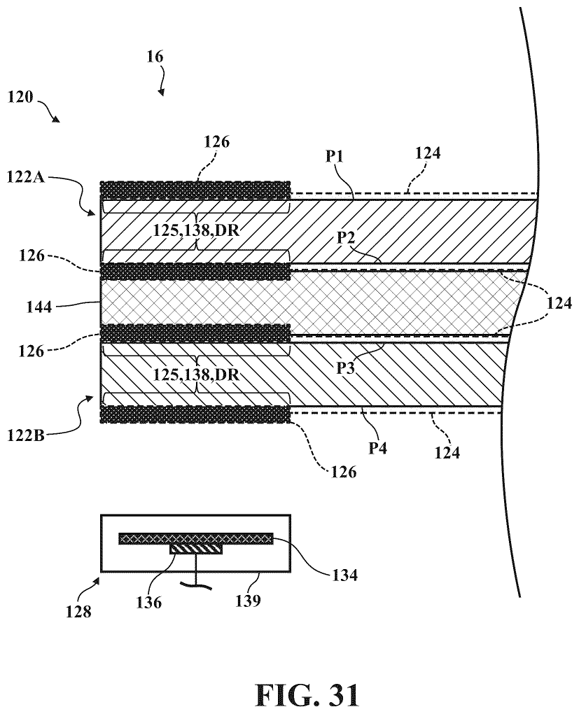

With continued reference to FIGS. 28-33B, in examples where the antenna assembly 128 is coupled to one of the first glass substrate 122A or the second glass substrate 122B, the radiating portion 134 may be printed or otherwise formed on one of the first glass substrate 122A or the second glass substrate 122B (see e.g. FIG. 28, described in further detail below), the antenna assembly 128 may include a carrier layer 137 coupled to one of the first glass substrate 122A or the second glass substrate 122B (e.g. via an adhesive) and supporting the radiating portion 134 (see e.g. FIG. 29, described in further detail below), or the antenna assembly 128 may be an antenna module including a housing 139 coupled to the one of the first glass substrate 122A or the second glass substrate 122B and enclosing the radiating portion 134 (see e.g. FIG. 30, described in further detail below). Other configurations where the antenna assembly 128 is coupled directly to one of the first glass substrate 122A or the second glass substrate 122B are contemplated. In examples where the antenna assembly 128 is spaced from the glass substrates 122A, 122B, the antenna assembly 128 may be an antenna module including a housing 139 supported elsewhere in the vehicle 18 or building 19 (see e.g. FIG. 31, described in further detail below); however, other configurations where the antenna assembly 28 is spaced from the glass substrates 122A, 122B are contemplated. In examples where one or more components of the antenna assembly 128 are disposed between the first glass substrate 122A and the second glass substrate 122B, the radiating portion 134 may be coupled to the P2 surface, the P3 surface, or a surface of the polymeric interlayer 144 and the feeding portion 136 may be coupled to the P4 surface (see e.g. FIGS. 32A-33B, described in further detail below).

Similar to FIGS. 25-27, the potential locations of the enamel 126 are illustrated in phantom in FIGS. 28-33B, with each layer of enamel 126 at least partially overlapping the other layers of enamel 126 such that the decoated region(s) DR at least partially overlap such that the antenna assembly 128 may transmit and/or receive radio frequency signals through each of the decoated region(s) DR. While FIGS. 28-33B illustrate in phantom the enamel 126 disposed on each of the P1 surface, the P2 surface, the P3 surface, and the P4 surface, it should be appreciated that the enamel 126 may be disposed on any single one of the P1 surface, the P2 surface, the P3 surface, and the P4 surface, or any combination thereof. For each of the configurations illustrated in FIGS. 28-33B, the radiating portion 134 may be arranged at least partially within the perimeter 138 of the decoated region(s) DR to transmit and/or receive radio frequency signals through the decoated region(s) DR, as described above.

FIG. 28 illustrates one example of the antenna assembly 128 where the radiating portion 134 is printed or otherwise formed on one of the first glass substrate 122A and the second glass substrate 122B. In these examples, the radiating portion 134 of the antenna assembly 128 may formed by virtue of screen-printing a conductive paste (e.g. silver paste) one of the first glass substrate 122A and the second glass substrate 122B and subsequently firing the conductive paste (this operation can be performed in conjunction with steps S103 and S104 or as an independent operation). In another example, the radiating portion 134 of the antenna assembly 128 is formed by virtue of digitally printing a conductive ink on one of the first glass substrate 122A and the second glass substrate 122B (this operation is typically performed after step S104 such that the conductive ink is not subject to excessive heat). Other techniques for printing or otherwise forming the radiating portion 134 on one of the first glass substrate 122A and the second glass substrate 122B are contemplated.

In the configuration illustrated in FIG. 28, the radiating portion 134 is printed or otherwise formed on the P4 surface of the second glass substrate 122B such that the laminated glazing assembly 120 shields the antenna assembly 128 from the environment outside the vehicle 18 or building 19, but other surfaces of the first glass substrate 122A and the second glass substrate 122B are contemplated. Here, the feeding portion 136 of the antenna assembly 128 is illustrated as a direct feeding structure including a coaxial cable coupled to the radiating portion 134 to energize the radiating portion 134 but other feeding arrangements are contemplated. Other configurations of the antenna assembly 128 where the radiating portion 134 is printed or otherwise formed on one of the first glass substrate 122A and the second glass substrate 122B are contemplated.

FIG. 29 illustrates one example of the antenna assembly 128 including a carrier layer 137 coupled to an outer surface of one of the first glass substrate 122A and the second glass substrate 122B and supporting the radiating portion 134. In these examples, the carrier layer 137 may comprise a printed circuit board (PCB) or a polymeric film comprising a suitable material such as polyethylene terephthalate (PET) or the like, and the radiating portion 134 may comprise a metallization layer (e.g. silver, copper, or the like) disposed on a surface of or encapsulated within the carrier layer 137. The carrier layer 137 may be coupled to the one of the first glass substrate 122A and the second glass substrate 122B with an adhesive such as polyurethane, an optically clear adhesive, or the like. In the configuration illustrated in FIG. 29, the carrier layer 137 is coupled to the P4 surface such that the laminated glazing assembly 120 shields the antenna assembly 128 from the environment outside the vehicle 18 or building 19. Here, the feeding portion 136 of the antenna assembly 128 is illustrated as a direct feeding structure including a coaxial cable coupled to the radiating portion 134 to energize the radiating portion 134 but other feeding arrangements are contemplated. Other configurations of the antenna assembly 128 where the radiating portion 134 is supported by a carrier layer 137 (e.g. where the carrier layer 137 and radiating portion are disposed between the first glass substrate 122A and the second glass substrate 122B, described in further detail below) are contemplated.

FIG. 30 illustrates one example of the antenna assembly 128 where the antenna assembly 128 is an antenna module including a housing 139 coupled to one of the first glass substrate 122A and the second glass substrate 122B and enclosing the radiating portion 134. In these examples, the housing 139 may comprise a suitable material (e.g. plastic) and the radiating portion 134 and/or the feeding portion 136 may be disposed within the housing 139. For example, the housing 139 may enclose a printed circuit board (PCB) which includes the radiating portion 134 and/or the feeding portion 136, but other configurations are contemplated. The housing 139 may be coupled to one of the first glass substrate 122A and the second glass substrate 122B directly with an adhesive such as polyurethane or the like, or the housing 139 may be indirectly coupled to one of the first glass substrate 122A and the second glass substrate 122B via a bracket or the like. In example illustrated in FIG. 30, the housing 139 is coupled to the P4 surface of the second glass substrate 122B such that the laminate glazing assembly 120 shields the antenna assembly 128 from the environment outside the vehicle 18 or building 19. Here, the feeding portion 136 of the antenna assembly 128 is illustrated as a direct feeding structure including a coaxial cable coupled to the radiating portion 134 to energize the radiating portion 134 but other feeding arrangements are contemplated. Other configurations of the antenna assembly 128 where the antenna assembly 128 is an antenna module including a housing 139 coupled to one of the first glass substrate 122A and the second glass substrate 122B are contemplated.

FIG. 31 illustrates one example of the antenna assembly 128 where the antenna assembly 128 is an antenna module including a housing 139 supported elsewhere in the vehicle 18 or building 19 and enclosing the radiating portion 134. For the purposes of FIG. 31, the antenna assembly 128 is schematically illustrated as spaced from the second glass substrate 122B. It should be appreciated that in these examples, the housing 139 may be supported at any suitable location within the interior of the vehicle 18 (e.g. within the dashboard, truck cargo shelf, etc.) or building 19. In any event, the housing 139 may be arranged such that the radiating portion 134 is arranged at least partially within the perimeter 138 of the decoated region DR to transmit and/or receive radio frequency signals through the decoated region(s) DR, as described above. For examples where the radiating portion 134 is implemented as a directional radiating portion 134, the housing 139 may be arranged within the vehicle 18 or building 19 such that the directionality of the radiating portion 134 is oriented through the decoated region(s) DR. Other configurations of the antenna assembly 128 where the antenna assembly 128 is an antenna module including a housing 139 supported elsewhere in the vehicle 18 or building 19 are contemplated.

FIGS. 32A-33B illustrate examples of the antenna assembly 128 where one or more components of the antenna assembly 128 are disposed between the first glass substrate 122A and the second glass substrate 122B. In these examples, the one or more components of the antenna assembly 128 disposed between the first glass substrate 122A and the second glass substrate 122B may be coupled to the P2 surface of the first glass substrate 122A, coupled to the P3 surface of the second glass substrate 122B, or coupled to a surface of the polymeric interlayer 144, where included. In the illustrated configurations, the radiating portion 134 of the antenna assembly 128 is disposed between the first glass substrate 122A and the second glass substrate 122B, but disposing additional or alternative components of the antenna assembly 128 between the first glass substrate 122A and the second glass substrate 122B is contemplated.

In the examples of FIGS. 32A and 32B, a passive radiating portion 134 is disposed between the first glass substrate 122A and the second glass substrate 122B. FIG. 32A illustrates one example where the passive radiating portion 134 is disposed between the P2 surface of the first glass substrate 122A and the polymeric interlayer 144, where included. FIG. 32B illustrates another example where the passive radiating portion 134 is disposed between the P3 surface of the second glass substrate 122B and the polymeric interlayer 144, where included. In these examples, the passive radiating portion 134 may be printed or otherwise formed on one of the P2 surface of the first glass substrate 122A, the P4 surface of the second glass substrate 122B, and the polymeric interlayer 144 according to the techniques described above. It is also contemplated that the antenna assembly 128 may include a carrier layer 137 supporting the passive radiating portion 134 disposed between the first glass substrate 122A and the second glass substrate 122B. For example, the carrier layer 137 supporting the passive radiating portion 134 may be coupled to one of the P2 surface of the first glass substrate 122A, the P4 surface of the second glass substrate 122B, and the polymeric interlayer 144 (where included) via an adhesive or the like. In the illustrated configurations, a feeding portion 136 implemented as a capacitive feeding element is disposed on the P4 surface of the second glass substrate 122B and capacitively coupled to the passing radiating portion 134 to energize the passive radiating portion 134 to transmit and/or receive radio frequency signals. Exemplary configurations of antenna assemblies 128 including a radiating portion 134 disposed between the first glass substrate 122A and the second glass substrate 122B are described in U.S. Patent App. Pub. No. 2024/0149563, published on Nov. 4, 2022 and assigned to AGC Automotive Americas Co., the contents of which is herein incorporated by reference in its entirety.

In the examples of FIGS. 33A and 33B, an active/steerable radiating portion 134 is disposed between the first glass substrate 122A and the second glass substrate 122B. FIG. 33A illustrates one example where the active/steerable radiating portion 134 is disposed between the P2 surface of the first glass substrate 122A and the polymeric interlayer 144, where included. FIG. 33B illustrates another example where the active/steerable radiating portion 134 is disposed between the P3 surface of the second glass substrate 122B and the polymeric interlayer 144, where included. In these examples, the antenna assembly 128 may include a carrier layer 137 supporting the active/steerable radiating portion 134 disposed between the first glass substrate 122A and the second glass substrate 122B. For example, the carrier layer 137 supporting the active/steerable radiating portion 134 may be coupled to one of the P2 surface of the first glass substrate 122A, the P4 surface of the second glass substrate 122B, and the polymeric interlayer 144 (where included) via an adhesive or the like. In the illustrated configurations, a feeding portion 136 is disposed on the P4 surface of the second glass substrate 122B and capacitively or otherwise coupled to the active/steerable radiating portion 134 to energize the active/steerable radiating portion 134 to transmit and/or receive radio frequency signals. Here, the feeding portion 136 may include a printed circuit board 146 or the like including feeding componentry in electromagnetic communication with the active/steerable radiating portion 134 to steer the field of view FOV of the active/steerable radiating portion 134 and to energize the active/steerable radiating portion 134 to transmit and/or receive radio frequency signals. Other configurations of a laminated glazing assembly 120 where one or more components of the antenna assembly 128 are disposed between the first glass substrate 122A and the second glass substrate 122B are contemplated.

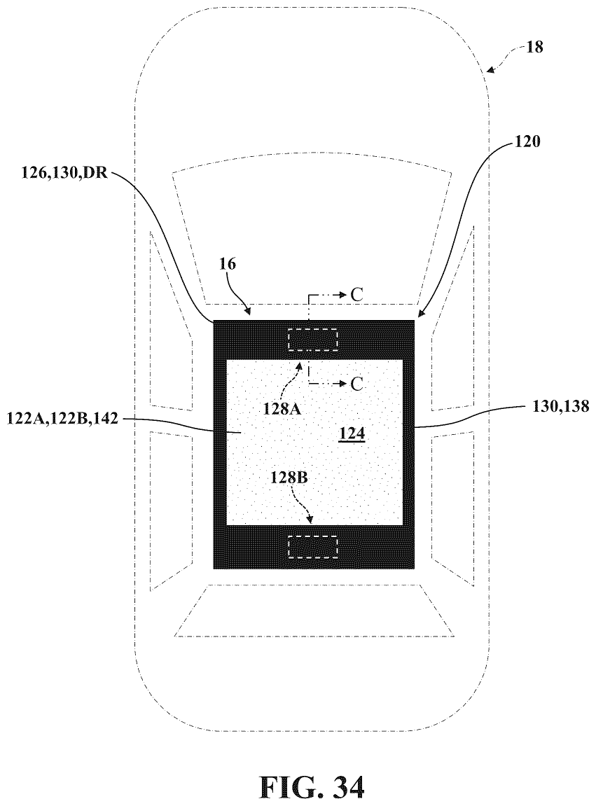

FIG. 34 schematically illustrates one example of the laminated glazing assembly 120 according to the present disclosure realized as a laminated roof glass panel 120 for a vehicle 18. The laminated roof glass panel 120 may generally have the any of the cross-sectional configurations illustrated above in the context of FIGS. 25-33B and may be formed according to the method 100 described in the context of FIG. 24. As best illustrated in FIG. 34, in some configurations, a plurality of antenna assemblies 128 may be disposed relative to one of the glass substrates 122A,122B to transmit and/or receive radio frequency signals through the decoated region(s) DR established via the enamel 126. For example, FIG. 34 shows a first antenna assembly 128A disposed within the perimeter 138 of the decoated region DR toward the front of the vehicle 18 and a second antenna assembly 128B disposed within the perimeter 138 of the decoated region DR toward the rear of the vehicle 18. In these examples, the plurality of antenna assemblies 128 may be directional antenna assemblies 128. For example, in the configuration of FIG. 34, the directionality of the first antenna assembly 128A may be generally arranged to transmit and/or receive radio frequency signals in the forward direction of the vehicle 18 and the directionality of the second antenna assembly 128B may be generally arranged to transmit and/or receive radio frequency signals in the rearward direction of the vehicle 18. Other configurations of a plurality of directional antenna assemblies 128 arranged to achieve a desired coverage of reception and/or transmission of radio frequency signals are contemplated. In other examples, the plurality of antenna assemblies 128 may be configured as a mix of dedicated antennas for transmitting radio frequency signals (i.e., TX antenna assemblies) and dedicated antenna assemblies 128 for receiving radio frequency signals (i.e., RX antenna assemblies). Other configurations including a plurality of antenna assemblies 128 are contemplated.

FIG. 35 is a schematic cross-sectional representation of one exemplary laminated roof glass panel 120 according to the present disclosure taken along line C-C of FIG. 34. As described above, in some examples, the conductive coating 124 may be a first conductive coating 124A having a first composition and at least partially disposed on one of the P1 surface, the P2 surface, the P3 surface, and the P4 surface, and a second conductive coating 124B having a second composition, different from the first composition, may be at least partially disposed on another of the P1 surface, the P2 surface, the P3 surface, and the P4 surface. In the configuration illustrated in FIG. 35, the first conductive coating 124A is at least partially disposed on the P2 surface and comprises a metal (e.g. the first conductive coating 124A is implemented as an infrared reflective coating), and the second conductive coating 124B is at least partially disposed on the P4 surface and comprises a transparent conductive oxide (e.g. the second conductive coating 124B is implemented as a low emissivity coating). Here, the combination of an infrared reflective coating and a low emissivity coating in this example proves particularly advantageous for thermal management of heat transmitting through the laminated roof glass panel 120. Similar to as described above, in the configuration of FIG. 35, the enamel 126 is disposed relative to a first portion 125-1 of the first conductive coating 124A and over a second portion 125-2 of the second conductive coating 124B to at least partially dissolve the first portion 125-1 of the first conductive coating 124A to define a first decoated region DR-1 and to at least partially dissolve the second portion 125-2 of the second conductive coating 124B to define a second decoated region DR-2. Here, the first decoated region DR-1 and the second decoated region DR-2 at least partially overlap such that the antenna assembly 128 may transmit and/or receive radio frequency signals through the first decoated region DR-1 and the second decoated region DR-2. The antenna assembly 128 is illustrated schematically in FIGS. 34 and 35 and may be realized according to any of the configurations described or illustrated herein.

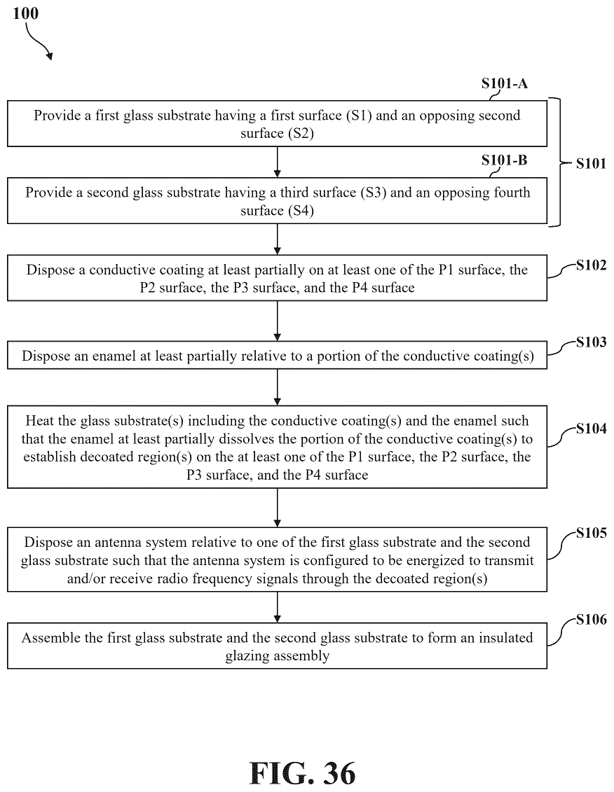

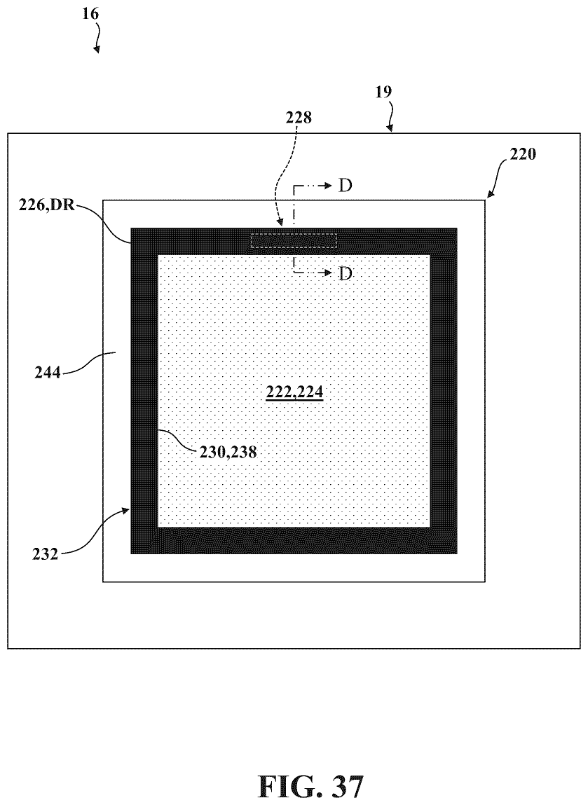

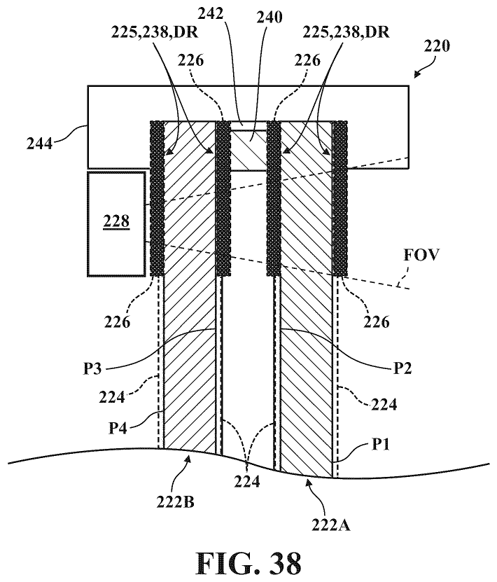

As alluded to above, in some examples, the glazing assembly 20 may be formed as an insulated glazing assembly 220 including multiple glass substrates 222 spaced apart from each other (e.g. double-paned building windows, triple-paned building windows, etc.). FIG. 36 is a flowchart illustrating a variation of the method 100 according to the present disclosure where the glazing assembly 20 is an insulated glazing assembly 220. FIGS. 37 and 38 schematically illustrate an insulated glazing assembly 220 implemented as a double-paned building window, but other configurations of insulated glazing assemblies 220 are contemplated.

Referring to FIG. 36, in these examples, the method 100 generally includes a first step S201 (similar to step S1 and step S104, described above) including a first sub-step 201-A of providing a first glass substrate 222A having a first surface (P1) and an opposing second surface (P2), and a second sub-step 201-B of providing a second glass substrate 222B having a third surface (P3) and an opposing fourth surface (P4). The first glass substrate 222A and second glass substrate 222B may be similar to the glass substrates described above. The first glass substrate 222A has a thickness T1 (similar to the glass substrate 22,122, described above), and the second glass substrate 222B has a thickness T2 (similar to the second glass substrate 122B, described above). For building applications, the thickness T1 and the thickness T2 may be from 3.0 mm to 12.0 mm or greater. Other values for the thickness T2 are contemplated. It should be appreciated that the thickness T1 of the first glass substrate 222A and the thickness T2 of the second glass substrate 222B can be the same or different. In some examples, the first glass substrate 222A and the second glass substrate 222B have the same composition. In other examples, the first glass substrate 222A and the second glass substrate 222B have different compositions.

With continued reference to FIG. 36, the method 100 also includes a second step S202 (similar to step S2 and step S102, described above) of at least partially disposing a conductive coating 224 on at least one of the P1 surface, the P2 surface, the P3 surface, and the P4 surface. Stated differently, a conductive coating 224 may be at least partially disposed on only the P1 surface, on only the P2 surface, on only the P3 surface, on only the P4 surface, or on any combination of the P1 surface, the P2 surface, the P3 surface, and the P4 surface. FIG. 38 illustrates the potential locations of the conductive coating 224 in phantom relative to the first glass substrate 222A and the second glass substrate 222B. The conductive coating 224 may be at least partially disposed on the on at least one of the P1 surface, the P2 surface, the P3 surface, and the P4 surface according to any of the exemplary processes described above in the context of step S2 and step S102 and may comprise any of the exemplary compositions described above in the context of step S2 and step S102. In some examples, the conductive coating 224 may be omitted from the surface of the glass substrate which faces the exterior of the vehicle 18 or building 19 (e.g. the P1 surface), particularly where the composition of the conductive coating 224 is not sufficiently durable to withstand being exposed to the environment outside of the vehicle 18 or building 19.

The conductive coating 224 may be at least partially disposed on more than one of the P1 surface, the P2 surface, the P3 surface, and the P4 surface. In certain examples where the conductive coating 224 is at least partially disposed on more than one of the P1 surface, the P2 surface, the P3 surface, and the P4 surface, the composition of the conductive coating 224 may be the same on each surface where the conductive coating 224 is disposed. In other examples, conductive coatings 224 having differing compositions may be disposed on each surface. Stated differently, in some examples, the conductive coating 224 may be a first conductive coating 224A having a first composition and at least partially disposed on one of the P1 surface, the P2 surface, the P3 surface, and the P4 surface, and a second conductive coating 224B having a second composition, different from the first composition, may be at least partially disposed on another of the P1 surface, the P2 surface, the P3 surface, and the P4 surface.

Referring back to FIG. 36, the method 100 further includes a third step S203 (similar to step S3 and step S103, described above) of at least partially disposing an enamel 226 relative to a portion 225 of the conductive coating(s) 224. The enamel 226 may be disposed relative to the portion 225 of the conductive coating(s) 224 according to any of the exemplary processes described above in the context of step S3 and step S103 and may comprise any of the exemplary compositions described above in the context of step S3 and step S103. Furthermore, similar to as described above, it should be appreciated that the order in which step S202 and step S203 are carried out may be switched in certain examples. FIG. 38 illustrates the potential locations of the enamel 226 in phantom relative to the first glass substrate 222A and the second glass substrate 222B. Similar to as described above in the context of step S3 and step S103, where the conductive coating 224 is at least partially disposed on only one of the P1 surface, the P2 surface, the P3 surface, and the P4 surface, the enamel 226 is at least partially disposed relative to the portion 225 of the conductive coating 224 to at least partially dissolve the adjacent portion 225 of the conductive coating 224 to define a decoated region DR when subjected to step S204.

For examples where a conductive coating 224 is disposed on more than one of the P1 surface, the P2 surface, the P3 surface, and the P4 surface, the enamel 226 is disposed relative to a respective portion 225 of each conductive coating 224 to at least partially dissolve the respective portion 225 of each the conductive coating 224 to define a respective decoated region DR when subjected to step S104. Typically, as illustrated by the potential locations of the enamel 226 in phantom in FIG. 38, each layer of enamel 226 at least partially overlaps the other layers of enamel 226 such that the decoated regions DR of each conductive coating 224 at least partially overlap such that the antenna assembly 28 may transmit and/or receive radio frequency signals through each of the decoated regions DR.

Similar to as described above in the context of step S3 and S103, as best shown in FIG. 37, in some examples, the portion 225 of the conductive coating 224 relative to which the enamel 226 is disposed is defined such that the enamel 226 is formed as a band 230 extending around a peripheral edge 232 of the insulated glazing assembly 220. In these examples, the band 230 blocks transmission of light through the region of the insulated glazing assembly 220 extending around the peripheral edge 232. Here, the antenna assembly 228 may be disposed beneath the band 230 such that the antenna assembly 228 may transmit and/or receive radio frequency signals through the decoated region DR defined by the band 230.

Referring back to FIG. 36, the method 100 additionally includes a fourth step S204 (similar to step S4 and step S204, described above) of heating the glass substrate(s) 222A, 222B which include the conductive coating(s) 224 and the enamel 226 disposed thereon such that the enamel 226 at least partially dissolves the adjacent portion(s) 225 of the conductive coating(s) 224 to establish decoated region(s) DR on the at least one of the P1 surface, the P2 surface, the P3 surface, and the P4 surface such that the decoated region(s) DR permit transmission of radio frequency signals therethrough. Generally, step S204 may be carried out according to any of the exemplary processes described above in the context of step S4 and step S104.

Referring back to the flowchart of FIG. 36, the method 100 additionally include a fifth step S205 of disposing an antenna assembly 228 relative to the insulated glazing assembly 220 (e.g. relative to one of the first glass substrate 222A and the second glass substrate 222B) such that the antenna assembly 228 is configured to be energized to transmit and/or receive radio frequency signals through the decoated region(s) DR. As used herein, the phrases “disposed relative to the insulated glazing assembly 220” or “disposed relative to one of the first glass substrate 222A and the second glass substrate 222B” encompasses configurations where the antenna assembly 228 is coupled to the first glass substrate 222A, the antenna assembly 228 is coupled to the second glass substrate 222B, the antenna assembly 228 is disposed between the first glass substrate 222A and the second glass substrate 222B, or the antenna assembly 228 is spaced from the first glass substrate 222A and the second glass substrate 222B (e.g. supported elsewhere in the vehicle 18 or building 19). In the context of insulated glazing assemblies 220, it should be appreciated that the antenna assembly 228 may be specifically configured for disposal relative to/within insulated glass assemblies 220. For example, in some configurations, one or more components of the antenna assembly 228 may be disposed between the first glass substrate 222A and the second glass substrate 222B.

The implementation of the antenna assembly 228 is not necessarily limited for the purposes of this disclosure and may generally include any system configured to transmit and/or receive radiofrequency signals. For example, the antenna assembly 228 may have any of the exemplary structures described above in the context of step S5 and step S105. In some configurations, the antenna assembly 228 may be a standalone assembly configured to be coupled to another device (e.g. a modem or the like) which energizes/operates the antenna assembly 228. In other configurations, the antenna assembly 228 may be incorporated within a device (e.g. a cell phone, tablet, computer, etc.). Other configurations of the antenna assembly 228 are contemplated. The antenna assembly 228 may be configured to transmit and/or receive radio frequency signals having linear polarization (e.g. vertical polarization and/or horizontal polarization) and/or circular polarization through the decoated region(s) DR. The antenna assembly 228 is configured to transmit and/or receive radio signals within the frequencies/via the protocols described above in the context of the antenna assembly 28. It should be appreciated that the operating frequency of the antenna assembly 228 is not necessarily limited for the purposes of this disclosure.

Similar to as described above in the context of step S5 and step S105, in the context of insulated glazing assembles 220, the decoated region(s) DR may define a perimeter 238 (best shown in FIG. 37), and the antenna assembly 228 may be disposed relative to one of the first glass substrate 222A and the second glass substrate 222B such that at least a portion of the antenna assembly 228 (e.g. a radiating portion) is arranged within the perimeter 238 of the decoated region(s) DR to transmit and/or receive radio frequency signals through the decoated region DR. FIG. 38 schematically illustrates the antenna assembly 228 is disposed relative to the P4 surface of the second glass substrate 222B, which faces the interior of the vehicle 18 or building 19, such that the antenna assembly 228 transmits and/or receives radio frequency signals through the decoated region(s) DR and is shielded from the exterior of the vehicle 18 or building 19 by the second glass substrate 222B. As best shown schematically in FIG. 38, especially in examples where the antenna assembly 228 includes a directional radiating portion 234, the antenna assembly 228 may have a field of view FOV, and the perimeter 238 of the decoated region(s) DR may be defined such that the conductive coating(s) 224 do not obstruct the field of view FOV of the antenna assembly 228. The field of view FOV of the antenna assembly 228 may be static, or the field of view FOV of the antenna assembly 228 may be adjustable (e.g. where the antenna assembly 228 includes an active/steerable radiating portion 234). In examples where the field of view FOV of the antenna assembly 228 is adjustable, the perimeter 238 of the decoated region(s) DR may be defined such that the conductive coating(s) 224 do not obstruct the field of view FOV of the antenna assembly 228 at any point within its adjustability. In examples where the antenna assembly 228 is disposed relative to the P4 surface (such as shown in FIG. 38) and the decoated region(s) DR are established on more than one of the P1 surface, the P2 surface, the P3 surface, and the P4 surface, the perimeter 238 of the decoated region DR on one surface may be different than the perimeter 238 of the decoated region DR on another surface to ensure that each of the conductive coatings 224 do not obstruct the field of view FOV of the antenna assembly 228.

In context of insulated glazing assemblies 220, similar to as described above in the context of FIGS. 17 to 19, the decoated region(s) DR may define a specific geometry configured to facilitate electromagnetic cooperation of the conductive coating(s) 224 with the antenna assembly 228 to facilitate the antenna assembly 228 transmitting and/or receiving radio frequency signals. For example, the decoated region DR may shaped such that a portion of the conductive coating 224 is configured to function as a radiating element, and the decoated region DR may define additional geometries of the conductive coating 224 configured to electromagnetically augment the antenna assembly 228 transmitting and/or receiving radio frequency signals (e.g., signal enhancing structures such as a resonant ring or the like), or the decoated region DR may be patterned to constitute a frequency selective surface. Other configurations where the decoated region DR defines a specific geometry configured to facilitate electromagnetic cooperation of the conductive coating 224 with the antenna assembly 228 to facilitate the antenna assembly 128 transmitting and/or receiving radio frequency signals through the decoated region DR are contemplated. For example, in some configurations, the decoated region DR may be defined such that the conductive coating 224 functions as a ground plane which electromagnetically cooperates with a radiating portion of the antenna assembly 228 to transmit and/or receive radio frequency signals through the decoated region DR.

With continued reference to the flowchart of FIG. 36, the method 100 additionally includes a sixth step S106 of assembling the first glass substrate 222A and the second glass substrate 222B to form the insulated glazing assembly 220. Here, the first glass substrate 222A may be spaced apart from the second glass substrate 222B, and one or more spacer 240 may be disposed between the first glass substrate 222A and the second glass substrate 222B to define the spacing between the glass substrates 222A,222B. One or more seals 242 may be disposed relative to the spacer(s) 240 to seal the space between the glass substrates 222A,222B. In some examples, a vacuum is maintained in the space between the first glass substrate 222A and the second glass substrate 222B. In other examples, fill gasses (e.g. argon) disposed in the space between the glass substrates 222A,222B to reduce heat transfer. The insulated glazing assembly 220 also typically includes a frame 244 surrounding the peripheral edges 232 of the insulated glazing assembly 220 to facilitate installation of the insulated glazing assembly 220 in a building 19 or vehicle 18 Other configurations of assembling the first glass substrate 222A and the second glass substrate 222B to form the insulated glazing assembly 220. For example, the insulated glazing assembly 220 may include additional glass substrates 222 and/or other structural arrangements for sealing the space between the glass substrates 222.

Several embodiments have been described in the foregoing description. However, the embodiments described herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

Various additional alterations and changes beyond those already mentioned herein can be made to the above-described embodiments. This disclosure is presented for illustrative purposes and should not be interpreted as an exhaustive description of all embodiments or to limit the scope of the claims to the specific elements illustrated or described in connection with these embodiments. For example, and without limitation, any individual element(s) of the described embodiments may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Any reference to claim elements in the singular, for example, using the articles “a,” “an,” “the” or “said,” is not to be construed as limiting the element to the singular. It will be further appreciated that the terms “include,” “includes,” and “including” have the same meaning as the terms “comprise,” “comprises,” and “comprising.”

What is claimed is:

1. A system for facilitating radio frequency transmission, said system comprising:
a glazing assembly comprising:
a glass substrate having a first surface and an opposing second surface;
a conductive coating at least partially disposed on at least one of said first surface and said second surface of said glass substrate, wherein said conductive coating inhibits transmission of radio frequency signals therethrough; and
an enamel at least partially disposed relative to a portion of said conductive coating to at least partially dissolve said portion of said conductive coating to establish a decoated region on said at least one of said first surface and said second surface to permit transmission of radio frequency signals therethrough; and
an antenna assembly arranged relative to said glazing assembly such that said antenna assembly is configured to be energized to transmit and/or receive radio frequency signals through said decoated region.

2. The system according to claim 1, wherein said decoated region is substantially free of said conductive coating.

3. The system according to claim 1, wherein said conductive coating has a first conductivity and said decoated region has a second conductivity, wherein said second conductivity is less than said first conductivity.

4. The system according to claim 1, wherein said decoated region defines a perimeter and wherein said antenna assembly is arranged relative to said glazing assembly such that at least a portion of said antenna assembly is arranged within said perimeter of said decoated region to transmit and/or receive radio frequency signals through said decoated region.

5. The system according to claim 1, wherein said antenna assembly has a field of view in which the antenna assembly is configured to transmit and/or receive radio frequency signals; and
wherein a perimeter of said decoated region is defined such that said conductive coating does not obstruct said field of view of said antenna assembly.

6. The system according to claim 1, wherein said enamel is a first enamel; and
wherein said glazing assembly further comprises a second enamel, different from said first enamel, disposed over at least a portion of said first enamel to protect said first enamel.

7. A system for facilitating radio frequency transmission, said system comprising:
a laminated glazing assembly comprising:
a first glass substrate having a first surface (P1) and an opposing second surface (P2);
a second glass substrate having a third surface (P3) and an opposing fourth surface (P4);
a polymeric interlayer disposed between said P2 surface and said P3 surface;
a conductive coating at least partially disposed on at least one of said P1 surface, said P2 surface, said P3 surface, and said P4 surface, wherein said conductive coating inhibits transmission of radio frequency signals therethrough; and
an enamel at least partially disposed relative to a portion of said conductive coating to at least partially dissolve said portion of said conductive coating to define a decoated region on said at least one of said P1 surface, said P2 surface, said P3 surface, and said P4 surface to permit transmission of radio frequency signals therethrough; and
an antenna assembly arranged relative to said laminated glazing assembly such that said antenna assembly is configured to be energized to transmit and/or receive radio frequency signals through said decoated region.

8. The system according to claim 7, wherein said decoated region is substantially free of said conductive coating.

9. The system according to claim 7, wherein said conductive coating has a first conductivity and said decoated region has a second conductivity, wherein said second conductivity is less than said first conductivity.

10. The system according to claim 7, wherein said decoated region defines a perimeter and wherein said antenna assembly is arranged relative to said laminated glazing assembly such that said antenna assembly is arranged within said perimeter of said decoated region to transmit and/or receive radio frequency signals through said decoated region.

11. The system according to claim 7, wherein said antenna assembly has a field of view in which the antenna assembly is configured to transmit and/or receive radio frequency signals; and
wherein a perimeter of said decoated region is defined such that said conductive coating does not obstruct said field of view of said antenna assembly.

12. The system according to claim 7, wherein said conductive coating is a first conductive coating at least partially disposed on one of said P1 surface, said P2 surface, said P3 surface, and said P4 surface; and
wherein said glazing assembly further comprises a second conductive coating at least partially disposed on another of said P1 surface, said P2 surface, said P3 surface, and said P4 surface; and
wherein said enamel is at least partially disposed relative to a first portion of said first conductive coating and at least partially disposed relative to a second portion of said second conductive coating to at least partially dissolve said first portion of said first conductive coating to define a first decoated region to permit transmission of radio frequency signals therethrough and to at least partially dissolve said second portion of said second conductive coating to define a second decoated region to permit transmission of radio frequency signals therethrough.

13. The system according to claim 12, wherein said first decoated region and said second decoated region at least partially overlap; and
wherein said antenna assembly is arranged relative to said laminated glazing assembly such that said antenna assembly is configured to transmit and/or receive radio frequency signals through said first decoated region and said second decoated region.

14. The laminated glazing assembly according to claim 7, wherein said antenna assembly comprises:
a radiating portion disposed on at least one of said P2 surface of said first glass substrate, said P3 surface of said second glass substrate, and said polymeric interlayer; and
a feeding portion disposed on said P4 surface of said second glass substrate and capacitively coupled to said radiating portion to energize said antenna assembly to transmit and/or receive radio frequency signals.

15. A method comprising:
providing a glass substrate having a first surface and an opposing second surface;
disposing a conductive coating at least partially on at least one of the first surface and the second surface of the glass substrate, wherein the conductive coating inhibits transmission of radio frequency signals therethrough;
disposing an enamel at least partially relative to a portion of the conductive coating;
heating the glass substrate, the conductive coating, and the enamel such that the enamel at least partially dissolves the portion of the conductive coating to establish a decoated region on the at least one of the first surface and the second surface to permit transmission of radio frequency signals therethrough; and
disposing an antenna assembly relative to the glass substrate such that the antenna assembly is configured to be energized to transmit and/or receive radio frequency signals through the decoated region.

16. The method according to claim 15, wherein said step of disposing an enamel at least partially relative to a portion of the conductive coating comprises disposing the enamel over the portion of the conductive coating.

17. The method according to claim 15, wherein said step of disposing a conductive coating at least partially on at least one of the first surface and the second surface of the glass substrate further comprises disposing the portion of the conductive coating over the enamel.

18. The method according to claim 15, wherein said step of heating the glass substrate, the conductive coating, and the enamel comprises heating the glass substrate, the conductive coating, and the enamel at a firing temperature from 550° C. to 700° C.

19. The method according to claim 15, wherein the enamel comprises a first enamel;
wherein said method further comprises disposing a second enamel, different from the first enamel, over at least a portion of the first enamel; and
wherein said step of heating the glass substrate, the conductive coating, and the first enamel further comprises heating the second enamel.

20. The method according to claim 15, wherein the glass substrate is a first glass substrate having the first surface (P1) and the opposing second surface (P2); and
wherein said method further comprises providing a second glass substrate having a third surface (P3) and an opposing fourth surface (P4) and disposing the second glass substrate relative to the first glass substrate.

21. The method according to claim 20, wherein the conductive coating is a first conductive coating and the decoated region is a first decoated region, and wherein said method further comprises disposing a second conductive coating at least partially on at least one of the P3 surface and the P4 surface;
wherein said method further comprises disposing the enamel at least partially relative to a portion of the second conductive coating; and
wherein said method further comprises heating the second glass substrate, the second conductive coating, and the enamel disposed at least partially relative to the second conductive coating such that the enamel at least partially dissolves the portion of the second conductive coating to establish a second decoated region on the at least one of the P3 surface and the P4 surface to permit transmission of radio frequency signals therethrough.

22. The method according to claim 21, wherein the first decoated region and the second decoated region at least partially overlap; and
wherein the antenna assembly is disposed relative to one of the first glass substrate and the second glass substrate such that the antenna assembly is configured to transmit and/or receive radio frequency signals through the first decoated region and the second decoated region.
